(19) United States
(12) Patent Application Publication
(10) Pub. No.: US 2026/0140353 A1
(43) Pub. Date: May 21, 2026

(54) ZOOM LENS AND PHOTOGRAPHING DEVICE

(71) Applicant: BEIJING XIAOMI MOBILE SOFTWARE CO., LTD., Beijing (CN)

(72) Inventor: Yasuhiko OBIKANE, Tokyo (JP)

(21) Appl. No.: 19/119,355

(22) PCT Filed: Oct. 19, 2022
(86) PCT No.: PCT/CN2022/126283

§ 371 Date: Apr. 15, 2025

(51) Int. Cl. G02B 15/14; G02B 15/16

(52) U.S. Cl. CPC G02B 15/1425; G02B 15/16

(57) ABSTRACT

A zoom lens and a photographing device are provided. The zoom lens includes a first lens group with a negative refractive power and a second lens group with a positive refractive power in sequence from an object side. In a case of zooming from a wide-angle end to a telephoto end, the first lens group and the second lens group move by different trajectories to reduce an interval therebetween, and a following conditional expression is satisfied: 0.38≤OAL2/OALw≤0.80 where OAL2 is an axial length of the second lens group from the object side to an image side; and OALw is an axial length of the first lens group at the wide-angle end from the object side to an image plane.

### CROSS-REFERENCE TO RELATED APPLICATION

The present application is a U.S. National Stage of International Application No. PCT/CN2022/126283, filed on Oct. 19, 2022, the contents of all of which are incorporated herein by reference in their entireties for all purposes.

### BACKGROUND

In the ongoing efforts to make photographing devices thinner for use, for example, in a smart phone, there is a tendency to avoid including a zoom lens because it will increase a thickness of a product. For example, in some smart phones, a plurality of photographing units including monofocal lenses with different view angles are provided, and a pseudo zoom lens function is realized by digital zooming and switching of the photographing units according to a view angle at which a user wants to photograph.

On the other hand, in a telephoto zoom lens, a prism is arranged on an object side to bend an optical path, so that a thinner product may be achieved, even for an optical system with a long optical path length.

### SUMMARY

The present disclosure relates to a zoom lens and a photographing device.

A zoom lens in a first embodiment of the present disclosure includes a first lens group with a negative refractive power and a second lens group with a positive refractive power in sequence from an object side. When zooming from a wide-angle end to a telephoto end, the first lens group and the second lens group move by different trajectories to reduce an interval therebetween, and a following conditional expression is satisfied.

$$0.38 \leq OAL 2 / OALw \leq 0.80 \qquad ( 1 )$$

Where OAL2 is an axial length of the second lens group from the object side to an image side and OALw is an axial length of the first lens group at the wide-angle end from the object side to an image plane.

A zoom lens in a second embodiment of the present disclosure includes a first lens group with a negative refractive power and a second lens group with a positive refractive power in sequence from an object side. When zooming from a wide-angle end to a telephoto end, the first lens group and the second lens group move by different trajectories to reduce an interval therebetween, and a following conditional expression is satisfied.

$$- 5.00 \leq f 1 / f 2 \leq - 1.30 \qquad ( 2 )$$

Where f1 is a focal length of the first lens group and f2 is a focal length of the second lens group.

A zoom lens in a third embodiment of the present disclosure has a first lens group with a negative refractive power and a second lens group with a positive refractive power in sequence from an object side. When zooming from a wide-angle end to a telephoto end, the first lens group and the second lens group move by different trajectories to reduce an interval therebetween, and a following conditional expression is satisfied.

$$0.1 \leq f 2 / \sqrt{( f w \times f t )} \leq 0.90 \qquad ( 3 )$$

Where f2 is a focal length of the second lens group, f2 is a focal length at the wide angle end and ft is a focal length at the telephoto end.

A zoom lens in a fourth embodiment of the present disclosure has a first lens group with a negative refractive power and a second lens group with a positive refractive power in sequence from an object side. When zooming from a wide-angle end to a telephoto end, the first lens group and the second lens group move by different trajectories to reduce an interval therebetween, and a following conditional expression is satisfied.

$$- 10.00 \leq L 1 R 1 / L 1 R 2 \leq 0.90 \qquad ( 4 )$$

where L1R1 is a radius of curvature of an object-side surface of a lens closest to the object side and L1R2: a radius of curvature of an image-side surface of the lens closest to the object side.

A photographing device in a fifth embodiment of the present disclosure includes the zoom lens in any of the first to fourth embodiments, and a photographing element that converts a formed optical image into an electrical signal.

### BRIEF DESCRIPTION OF THE DRAWINGS

FIG. 1 (A) is a view showing a wide-angle end state of a zoom lens according to a first embodiment, FIG. 1 (B) is a view showing an intermediate focus position state, FIG. 1 (C) is a lens layout view showing a telephoto end state, and FIG. 1 (D) is a diagram showing a change of a first lens group and a second lens group from the wide-angle end state to the telephoto end state.

FIG. 2 is a longitudinal aberration diagram of the wide-angle end state of the first embodiment.

FIG. 3 is a longitudinal aberration diagram of the intermediate focus position state of the first embodiment.

FIG. 4 is a longitudinal aberration diagram of the telephoto end state of the first embodiment.

FIG. 5 (A) is a view showing a wide-angle end state of a zoom lens according to a second embodiment, FIG. 5 (B) is a view showing an intermediate focus position state, FIG. 5 (C) is a lens layout view showing a telephoto end state, and FIG. 5 (D) is a diagram showing a change of a first lens group and a second lens group from the wide-angle end state to the telephoto end state.

FIG. 6 is a longitudinal aberration diagram of the wide-angle end state of the second embodiment.

FIG. 7 is a longitudinal aberration diagram of the intermediate focus position state of the second embodiment.

FIG. 8 is a longitudinal aberration diagram of the telephoto end state of the second embodiment.

FIG. 9 (A) is a view showing a wide-angle end state of a zoom lens according to a third embodiment, FIG. 9 (B) is a view showing an intermediate focus position state, FIG. 9 (C) is a lens layout view showing a telephoto end state, and FIG. 9 (D) is a diagram showing a change of a first lens group and a second lens group from the wide-angle end state to the telephoto end state.

FIG. 10 is a longitudinal aberration diagram of the wide-angle end state of the third embodiment.

FIG. 11 is a longitudinal aberration diagram of the intermediate focus position state of the third embodiment.

FIG. 12 is a longitudinal aberration diagram of the telephoto end state of the third embodiment.

FIG. 13 (A) is a view showing a wide-angle end state of a zoom lens according to a fourth embodiment, FIG. 13 (B) is a view showing an intermediate focus position state, FIG. 13 (C) is a lens layout view showing a telephoto end state, and FIG. 13 (D) is a diagram showing a change of a first lens group and a second lens group from the wide-angle end state to the telephoto end state.

FIG. 14 is a longitudinal aberration diagram of the wide-angle end state of the fourth embodiment.

FIG. 15 is a longitudinal aberration diagram of the intermediate focus position state of the fourth embodiment.

FIG. 16 is a longitudinal aberration diagram of the telephoto end state of the fourth embodiment.

FIG. 17 (A) is a view showing a wide-angle end state of a zoom lens according to a fifth embodiment, FIG. 17 (B) is a view showing an intermediate focus position state, FIG. 17 (C) is a lens layout view showing a telephoto end state, and FIG. 17 (D) is a diagram showing a change of a first lens group and a second lens group from the wide-angle end state to the telephoto end state.

FIG. 18 is a longitudinal aberration diagram of the wide-angle end state of the fifth embodiment.

FIG. 19 is a longitudinal aberration diagram of the intermediate focus position state of the fifth embodiment.

FIG. 20 is a longitudinal aberration diagram of the telephoto end state of the fifth embodiment.

FIG. 21 (A) is a view showing a wide-angle end state of a zoom lens according to a sixth embodiment, FIG. 21 (B) is a view showing an intermediate focus position state, FIG. 21 (C) is a lens layout view showing a telephoto end state, and FIG. 21 (D) is a diagram showing a change of a first lens group and a second lens group from the wide-angle end state to the telephoto end state.

FIG. 22 is a longitudinal aberration diagram of the wide-angle end state of the sixth embodiment.

FIG. 23 is a longitudinal aberration diagram of the intermediate focus position state of the sixth embodiment.

FIG. 24 is a longitudinal aberration diagram of the telephoto end state of the sixth embodiment.

FIG. 25 (A) is a view showing a wide-angle end state of a zoom lens according to a seventh embodiment, FIG. 25 (B) is a view showing an intermediate focus position state, FIG. 25 (C) is a lens layout view showing a telephoto end state, and FIG. 25 (D) is a diagram showing a change of a first lens group and a second lens group from the wide-angle end state to the telephoto end state.

FIG. 26 is a longitudinal aberration diagram of the wide-angle end state of the seventh embodiment.

FIG. 27 is a longitudinal aberration diagram of the intermediate focus position state of the seventh embodiment.

FIG. 28 is a longitudinal aberration diagram of the telephoto end state of the seventh embodiment.

FIG. 29 (A) is a view showing a wide-angle end state of a zoom lens according to an eighth embodiment, FIG. 29 (B) is a view showing an intermediate focus position state, FIG. 29 (C) is a lens layout view showing a telephoto end state, and FIG. 29 (D) is a diagram showing a change of a first lens group and a second lens group from the wide-angle end state to the telephoto end state.

FIG. 30 is a longitudinal aberration diagram of the wide-angle end state of the eighth embodiment.

FIG. 31 is a longitudinal aberration diagram of the intermediate focus position state of the eighth embodiment.

FIG. 32 is a longitudinal aberration diagram of the telephoto end state of the eighth embodiment.

FIG. 33 (A) is a view showing a wide-angle end state of a zoom lens according to a ninth embodiment, FIG. 33 (B) is a view showing an intermediate focus position state, FIG. 33 (C) is a lens layout view showing a telephoto end state, and FIG. 33 (D) is a diagram showing a change of a first lens group and a second lens group from the wide-angle end state to the telephoto end state.

FIG. 34 is a longitudinal aberration diagram of the wide-angle end state of the ninth embodiment.

FIG. 35 is a longitudinal aberration diagram of the intermediate focus position state of the ninth embodiment.

FIG. 36 is a longitudinal aberration diagram of the telephoto end state of the ninth embodiment.

FIG. 37 (A) is a view showing a wide-angle end state of a zoom lens according to a tenth embodiment, FIG. 37 (B) is a view showing an intermediate focus position state, FIG. 37 (C) is a lens layout view showing a telephoto end state, and FIG. 37 (D) is a diagram showing a change of a first lens group and a second lens group from the wide-angle end state to the telephoto end state.

FIG. 38 is a longitudinal aberration diagram of the wide-angle end state of the tenth embodiment.

FIG. 39 is a longitudinal aberration diagram of the intermediate focus position state of the tenth embodiment.

FIG. 40 is a longitudinal aberration diagram of the telephoto end state of the tenth embodiment.

FIG. 41 (A) is a view showing a lens barrel in a wide-angle end state, FIG. 41 (B) is a view showing the lens barrel in a telephoto end state, and FIG. 41 (C) is a view showing the lens barrel in a storage state.

FIG. 42 is a schematic view showing a structure of a photographing device.

### DETAILED DESCRIPTION

An embodiment of the present disclosure will be described below with reference to the accompanying drawings.

Hereinafter, a zoom lens and a photographing device having the zoom lens of the present disclosure will be described through embodiments of the present disclosure using tables and drawings. In the following tables, r shown represents a radius of curvature, d represents a lens thickness or a lens interval, nd represents a refractive index of a d line, and vd represents a dispersion coefficient based on the d line (with a wavelength of 587.5620 nm). In addition, a surface number indicates an order of an optical surface from an object side along an advancing direction of light. In addition, “∞” of the radius of curvature indicates a plane or an opening, and the refractive index of air “1.000000” is omitted. When the optical surface is an aspheric surface, the opposite surface number is marked with *, and a paraxial curvature radius is indicated in a column of the radius of curvature r. In addition, the unit of “mm” is used for length unless otherwise specified, but an optical system may obtain the same optical performance even if it is enlarged or reduced, so that the present disclosure is not limited to this.

In addition, when c represents a curvature, k represents a conic coefficient, A4, A6, A8, A10 . . . represent aspheric coefficients of respective orders, and z represents a displacement in a direction of an optical axis at a position with a height h from the optical axis based on a surface vertex, an aspheric shape is defined by a following formula.

$$z = c {h}^{2} / [ 1 + {\{ 1 - ( 1 + k ) {c}^{2} {h}^{2} \}}^{1 / 2} ] + A 4 {h}^{4} + A 6 {h}^{6} + A 8 {h}^{8} + A 10 {h}^{10}$$

In addition, each longitudinal aberration diagram shows a spherical aberration (SA (mm)), an astigmatism (AST (mm)) and a distortion aberration (DIS (%)) in sequence from the left. In the spherical aberration diagram, a vertical axis represents an F number (denoted by FNO in the diagram), a solid line represents characteristics of the d line (d-line), a short dashed line represents characteristics of an F line (F-line), and a long dashed line represents characteristics of a C line (C-line). In the astigmatism diagram, a vertical axis represents a field of view angle (represented by W in the diagram), a solid line represents characteristics of a sagittal plane (represented by S in the diagram), and a dashed line represents characteristics of a meridian plane (represented by M in the diagram). In the distortion aberration diagram, a vertical axis represents a field of view angle (denoted by W in the diagram). It may be understood that the F number referred to in the present disclosure is a numerical value for indicating a size of an aperture, for example, f/1.8, f/4.0, f/16, etc. With the same focal length, the smaller the F number, the greater the light input and the larger the aperture, and the brighter it is.

In addition, an equivalent focal length refers to converting focal lengths of different lenses into equivalent focal lengths of a standard camera according to a certain proportional coefficient, in which the standard camera may be a full-frame camera. The method of converting the focal lengths of different lenses into the equivalent focal lengths of the standard camera may be found in the related art and will not be described here. A minimum focusing distance of the lens refers to a minimum distance between a photographed object and an image sensor when the lens is in focus, that is, a distance between a nearest object that the lens may photograph in focus and the image sensor.

A structure carrying a plurality of photographing units leads to an increase in a volume and a manufacturing cost of a product. In addition, when the photographing units are switched, sometimes the change of a field of view angle is discontinuous, which causes discomfort to a user. A structure of a zoom lens with a bent optical path needs to bend the optical path by about 90 degrees on an object side, so that it is difficult to realize a wide-angle zoom lens.

The present disclosure is made in order to solve this problem, and is intended to provide a zoom lens and a photographing device which are small and thin as a whole and may photograph with a wide angle, a high brightness and a high performance.

### First Embodiment

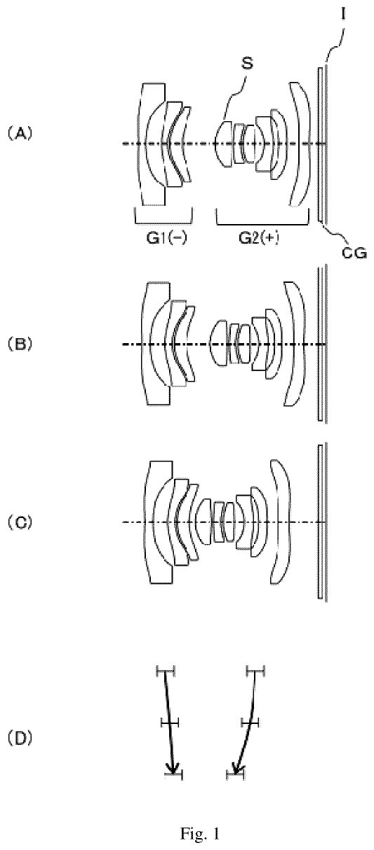

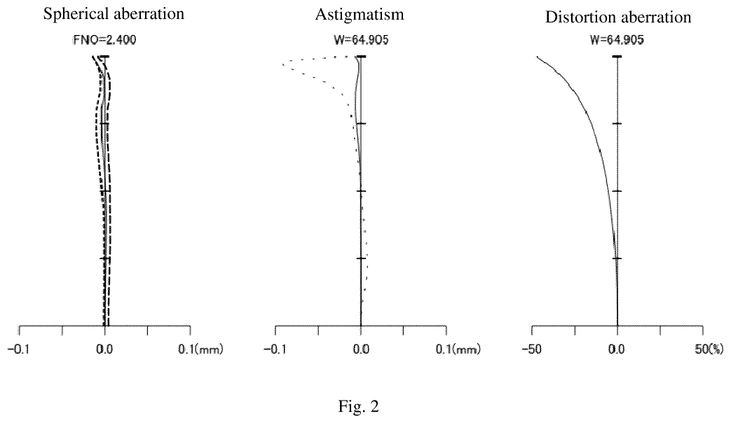

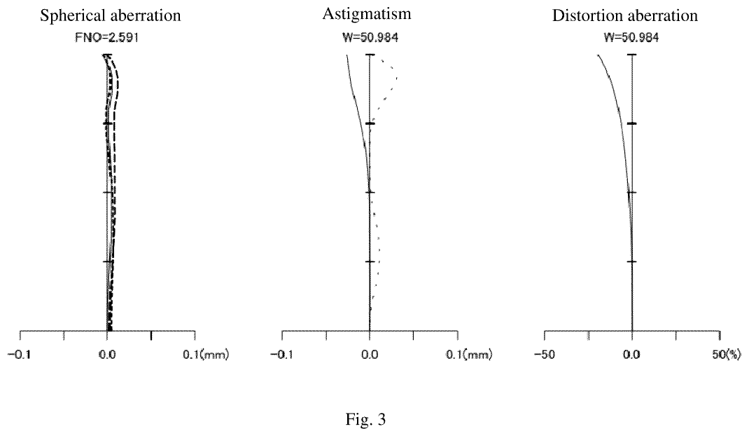

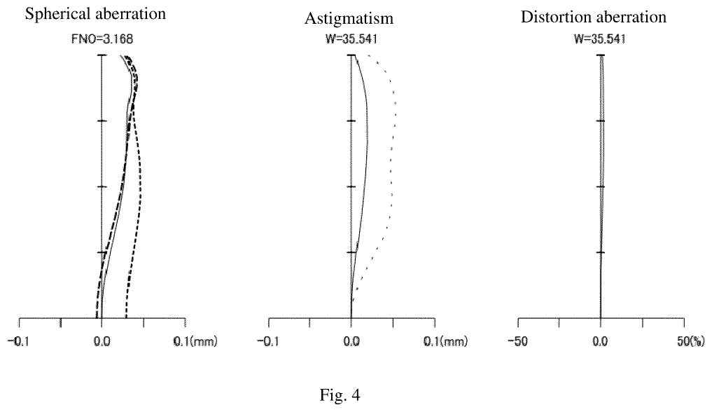

FIG. 1 is a lens layout view showing a wide-angle end state (FIG. 1 (A)), an intermediate focus position state (FIG. 1 (B)) and a telephoto end state (FIG. 1 (C)) of a zoom lens according to an embodiment (first embodiment) of this implementation, and a diagram showing a change of a first lens group G1 and a second lens group G2 from the wide-angle end state to the telephoto end state (FIG. 1 (D)). FIG. 2 is a longitudinal aberration diagram of the wide-angle end state of the first embodiment. FIG. 3 is a longitudinal aberration diagram of the intermediate focus position state of the first embodiment. FIG. 4 is a longitudinal aberration diagram of the telephoto end state of the first embodiment.

The zoom lens of the first embodiment has the first lens group G1 with a negative refractive power and the second lens group G2 with a positive refractive power, and an aperture stop S for adjusting a light quantity is arranged between the first lens group G1 and the second lens group G2. In addition, an optical filter CG including an infrared cut-off filter or the like is arranged between the second lens group G2 and an imaging position I.

In the first embodiment with the above configuration, in a process of zooming from the wide-angle end state to the telephoto end state, the first lens group G1 gradually moves toward an image side and the second lens group G2 gradually moves toward an object side. That is, the first lens group G1 and the second lens group G2 move by different trajectories to reduce an interval therebetween. The aperture stop S moves integrally with the second lens group G2.

In the following tables, values of parameters of the first embodiment are shown.

TABLE 1
Surface data

| Surface | | | | | |
|---|---|---|---|---|---|
| number | r | d | nd | vd | |
| 1* | −18.782 | 0.400 | 1.6161 | 25.78 | |
| 2* | 4.629 | 0.761 | | | |
| 3* | 3.013 | 0.350 | 1.5445 | 55.97 | |
| 4* | 2.048 | 0.100 | | | |
| 5* | 2.061 | 0.615 | 1.6714 | 19.27 | |
| 6* | 2.441 | d6 | | | |
| 7* | 1.655 | 0.823 | 1.5445 | 55.97 | (Aperture stop) |
| 8* | −9.996 | 0.100 | | | |
| 9* | 4.857 | 0.350 | 1.6714 | 19.27 | |
| 10* | 2.136 | 0.122 | | | |
| 11* | 2.264 | 0.585 | 1.5445 | 55.97 | |
| 12* | −17.358 | 0.477 | | | |
| 13* | −1.633 | 0.450 | 1.5731 | 37.65 | |
| 14* | −2.761 | 0.301 | | | |
| 15* | −4.273 | 0.400 | 1.5445 | 55.97 | |
| 16* | −13.570 | 0.566 | | | |
| 17* | 237.703 | 0.553 | 1.5445 | 55.97 | |
| 18* | 11.592 | d18 | | | |
| 19 | ∞ | 0.210 | 1.5168 | 64.17 | |
| 20 | ∞ | 0.240 | | | |

*represents aspheric surface

TABLE 2
Aspheric data (in which the aspheric coefficient not shown is 0.00)

| Surface | | | | | |
|---|---|---|---|---|---|
| number | k | A4 | A6 | A8 | A10 |
| 1 | −4.4610E+00 | 1.5289E−02 | −8.6882E−04 | −5.3772E−05 | 4.3309E−06 |
| 2 | −7.0062E−01 | 5.4184E−03 | 4.9257E−03 | −4.5925E−04 | 1.5555E−05 |
| 3 | −2.7988E+00 | −1.3822E−02 | −2.4831E−03 | 8.0378E−04 | −6.9709E−05 |
| 4 | −9.5791E−01 | 1.1885E−02 | −4.9879E−03 | −1.6917E−03 | 2.5399E−04 |
| 5 | −1.4353E+00 | −4.9559E−04 | 2.9223E−03 | −1.2407E−03 | −6.7728E−05 |
| 6 | −2.5521E+00 | −2.0202E−02 | 3.0270E−03 | 7.1789E−04 | −3.2260E−04 |
| 7 | −1.4213E−01 | −1.0732E−03 | 1.0575E−05 | −2.4319E−04 | 6.6013E−04 |
| 8 | 4.8735E+00 | 2.0198E−02 | −1.1298E−02 | 7.8437E−03 | −3.4054E−03 |
| 9 | −5.0000E+00 | −3.1727E−02 | −3.8438E−04 | 7.8967E−03 | −5.8079E−03 |
| 10 | 2.4163E+00 | −7.1273E−02 | −4.4610E−03 | 1.3112E−02 | −8.8640E−03 |
| 11 | 1.4774E+00 | −1.4037E−02 | −1.4632E−02 | 4.4186E−03 | 4.9783E−04 |
| 12 | 4.0106E+00 | −1.7859E−02 | −2.6860E−02 | −9.0087E−03 | −8.3009E−03 |
| 13 | −1.4744E+00 | −2.9008E−02 | −2.8258E−02 | −2.2292E−02 | −2.2424E−02 |
| 14 | −4.9979E+00 | 3.6536E−02 | 1.4616E−02 | −3.6927E−03 | −5.2687E−05 |
| 15 | 4.7724E+00 | −4.8053E−02 | −5.8360E−04 | 2.1002E−03 | −1.5234E−03 |
| 16 | 5.0000E+00 | −4.5011E−02 | 2.9737E−03 | −5.1154E−04 | −2.1604E−04 |
| 17 | 5.0000E+00 | −1.3257E−02 | −1.6995E−04 | 2.4324E−04 | −1.4775E−05 |
| 18 | −5.0000E+00 | −1.5284E−02 | 6.9626E−04 | 2.3697E−05 | −5.5290E−06 |
| Surface | | | | | |
| number | A12 | A14 | A16 | A18 | A20 |
| 1 | −8.0601E−09 | 8.3162E−12 | 8.4921E−21 | −1.0213E−22 | −4.1294E−24 |
| 2 | −1.2482E−17 | −2.7161E−19 | −5.8992E−21 | −1.6309E−22 | −4.1388E−24 |
| 3 | −2.1562E−08 | 6.0794E−10 | 4.4202E−12 | −1.1915E−12 | −2.2924E−18 |
| 4 | −4.2717E−07 | 9.1007E−09 | −1.2654E−14 | −1.7593E−16 | −2.5688E−18 |
| 5 | −2.3000E−06 | 9.6443E−08 | −2.4809E−14 | −4.0689E−16 | −6.5066E−18 |
| 6 | 7.3364E−07 | −1.5482E−08 | −2.6841E−14 | −4.1038E−16 | −6.5118E−18 |
| 7 | −3.6804E−04 | 5.1918E−05 | −2.6169E−14 | −4.0837E−16 | −6.5116E−18 |
| 8 | 2.6694E−04 | −2.0550E−05 | −5.9861E−21 | −1.5952E−22 | −4.1435E−24 |
| 9 | 9.4012E−04 | −1.0350E−04 | −2.6246E−14 | −4.0952E−16 | −6.5116E−18 |
| 10 | 1.9947E−03 | −2.1569E−04 | −2.6074E−14 | −4.0952E−16 | −6.5116E−18 |
| 11 | −5.1325E−05 | 2.0482E−06 | −6.2971E−15 | −8.1009E−17 | −1.0645E−18 |
| 12 | 1.3625E−05 | −2.3291E−06 | −6.1808E−15 | −8.1004E−17 | −1.0645E−18 |
| 13 | 1.3716E−16 | 1.7767E−18 | 2.1739E−20 | 2.2613E−22 | 1.2175E−24 |
| 14 | 1.4103E−16 | 1.7729E−18 | 2.1810E−20 | 2.2614E−22 | 1.2175E−24 |
| 15 | −1.0814E−17 | 7.4434E−20 | 1.1064E−21 | 1.9984E−23 | 2.7812E−25 |
| 16 | 1.6500E−17 | 1.1792E−19 | 1.3654E−21 | 1.6320E−23 | 2.7930E−25 |
| 17 | 6.4226E−08 | −1.9612E−09 | −3.7229E−14 | −3.8288E−16 | −6.5283E−18 |
| 18 | 8.9271E−08 | −3.3752E−10 | −2.9297E−10 | −4.8920E−16 | −6.7845E−18 |

TABLE 3
Various data (zoom ratio 1.555, image height 4.000)
Various data

| | Wide-angle | Intermediate | Telephoto |
|---|---|---|---|
| Focal length | 3.544 | 4.034 | 5.510 |
| F number | 2.400 | 2.591 | 3.168 |
| Half field of view | 64.905 | 50.984 | 35.541 |
| Total length of lens | 9.500 | 9.286 | 9.147 |
| d6 | 1.666 | 1.201 | 0.300 |
| d18 | 0.431 | 0.682 | 1.444 |

TABLE 4
Data of zoom lens groups

| | | | Configuration | Movement |
|---|---|---|---|---|
| | Initial | Focal | length of | amount of |
| Group | surface | length | lens | lens |
| 1 | 1 | −5.228 | 2.226 | −0.353 |
| 2 | 7 | 2.569 | 4.727 | 1.013 |

TABLE 5
Magnifications of zoom lens groups

| Group | Initial surface | Wide-angle | Intermediate | Telephoto |
|---|---|---|---|---|
| 1 | 1 | 0.000 | 0.000 | 0.000 |
| 2 | 7 | −0.678 | −0.772 | −1.054 |

### Second Embodiment

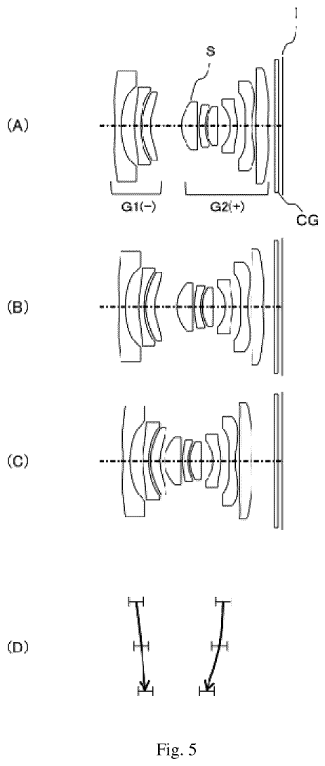

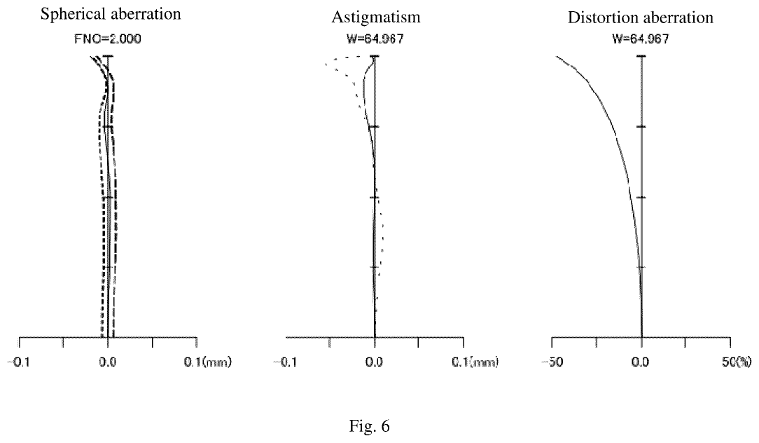

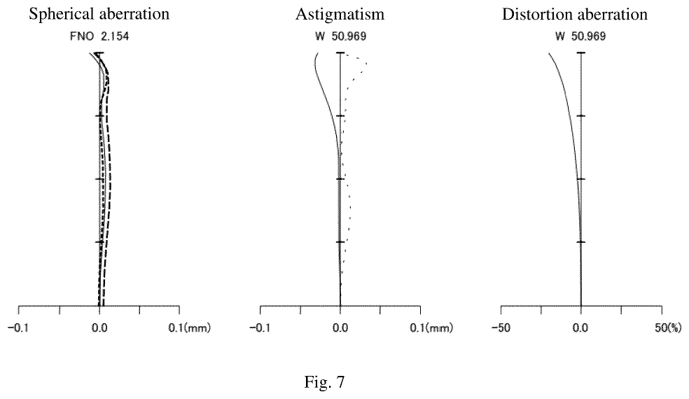

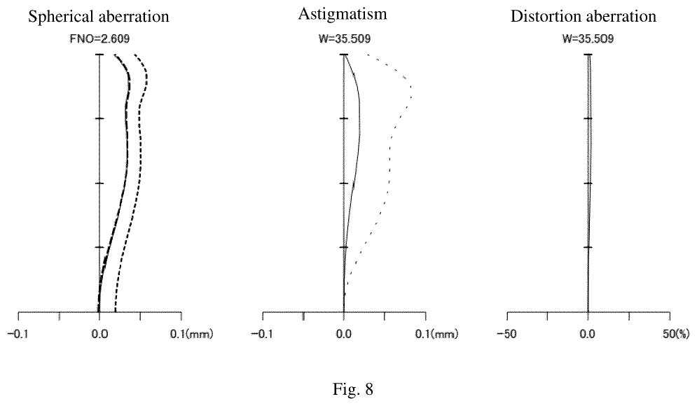

FIG. 5 is a lens layout view showing a wide-angle end state (FIG. 5 (A)), an intermediate focus position state (FIG. 5 (B)) and a telephoto end state (FIG. 5 (C)) of a zoom lens according to an embodiment (second embodiment) of this implementation, and a diagram showing a change of a first lens group G1 and a second lens group G2 from the wide-angle end state to the telephoto end state (FIG. 5 (D)). FIG. 6 is a longitudinal aberration diagram of the wide-angle end state of the second embodiment. FIG. 7 is a longitudinal aberration diagram of the intermediate focus position state of the second embodiment. FIG. 8 is a longitudinal aberration diagram of the telephoto end state of the second embodiment.

The zoom lens of the second embodiment has the first lens group G1 with a negative refractive power and the second lens group G2 with a positive refractive power, and an aperture stop S for adjusting a light quantity is arranged between the first lens group G1 and the second lens group G2. In addition, an optical filter CG including an infrared cut-off filter or the like is arranged between the second lens group G2 and an imaging position I.

In the second embodiment with the above configuration, in a process of zooming from the wide-angle end state to the telephoto end state, the first lens group G1 gradually moves toward an image side and the second lens group G2 gradually moves toward an object side. That is, the first lens group G1 and the second lens group G2 move by different trajectories to reduce an interval therebetween. The aperture stop S moves integrally with the second lens group G2.

In the following tables, values of parameters of the second embodiment are shown.

TABLE 6
Surface data

| Surface | | | | | |
|---|---|---|---|---|---|
| number | r | d | nd | vd | |
| 1* | −15.048 | 0.400 | 1.5445 | 55.97 | |
| 2* | 5.156 | 0.749 | | | |
| 3* | 5.420 | 0.350 | 1.5445 | 55.97 | |
| 4* | 5.165 | 0.100 | | | |
| 5* | 2.827 | 0.500 | 1.5731 | 37.65 | |
| 6* | 2.474 | d6 | | | |
| 7* | 1.873 | 0.933 | 1.5445 | 55.97 | (Aperture stop) |
| 8* | −132.197 | 0.100 | | | |
| 9* | 4.338 | 0.350 | 1.6714 | 19.27 | |
| 10* | 2.450 | 0.100 | | | |
| 11* | 2.163 | 0.640 | 1.5445 | 55.97 | |
| 12* | −355.506 | 0.700 | | | |
| 13* | −1.955 | 0.450 | 1.6397 | 23.49 | |
| 14* | −2.990 | 0.448 | | | |
| 15* | 12.929 | 0.400 | 1.5445 | 55.97 | |
| 16* | 3.710 | 0.244 | | | |
| 17* | 24.869 | 0.687 | 1.6714 | 19.27 | |
| 18* | 13.024 | d18 | | | |
| 19 | ∞ | 0.210 | 1.5168 | 64.17 | |
| 20 | ∞ | 0.240 | | | |

*represents aspheric surface

TABLE 7
Aspheric data (in which an aspheric coefficient not shown is 0.00)

| Surface | | | | | |
|---|---|---|---|---|---|
| number | k | A4 | A6 | A8 | A10 |
| 1 | −5.0000E+00 | 9.8855E−03 | −4.9216E−04 | −2.0119E−05 | 1.4610E−06 |
| 2 | −5.0000E+00 | 3.8105E−03 | 2.7079E−03 | −2.4588E−04 | 1.5913E−05 |
| 3 | −4.3069E+00 | −7.7299E−03 | −6.2033E−04 | 6.5396E−05 | 5.5149E−06 |
| 4 | 4.4601E+00 | 1.5562E−02 | −2.4363E−03 | −3.9311E−04 | 5.7266E−05 |
| 5 | −5.0000E+00 | 1.9131E−03 | 1.5707E−03 | −1.6076E−04 | −6.5013E−06 |
| 6 | −4.6898E+00 | −1.6894E−02 | 1.6400E−03 | 2.3371E−04 | −8.4345E−05 |
| 7 | −1.9406E−01 | −6.7537E−04 | 8.4752E−05 | 1.9983E−04 | −2.1964E−04 |
| 8 | −5.0000E+00 | 7.3102E−03 | −2.5892E−03 | −8.1772E−04 | 4.3717E−04 |
| 9 | −5.0000E+00 | −1.1961E−02 | −1.7689E−03 | −1.1079E−04 | 1.0977E−03 |
| 10 | 1.9291E+00 | −4.2892E−02 | −4.2241E−03 | 5.5407E−03 | 8.8457E−05 |
| 11 | 5.6804E−01 | −1.6063E−02 | −3.6083E−03 | 2.7157E−03 | 2.7697E−04 |
| 12 | −5.0000E+00 | 4.4344E−03 | −5.8856E−03 | −4.3053E−03 | 4.3741E−04 |
| 13 | −6.9196E−01 | −5.4014E−03 | −1.4078E−02 | −4.7920E−03 | −5.8907E−03 |
| 14 | −5.0000E+00 | 1.9044E−02 | 3.9872E−03 | 1.0855E−04 | −1.2630E−04 |
| 15 | 5.0000E+00 | −4.6554E−02 | −3.2004E−04 | 1.8878E−03 | −3.1948E−04 |
| 16 | −5.0000E+00 | −3.0795E−02 | 4.1425E−03 | −3.7222E−04 | 1.9373E−06 |
| 17 | −2.5643E+00 | −7.6307E−03 | 1.1700E−03 | −6.4033E−05 | 6.1361E−07 |
| 18 | 4.2565E+00 | −1.6918E−02 | 1.3881E−03 | 5.7356E−06 | −3.9020E−06 |
| Surface | | | | | |
| number | A12 | A14 | A16 | A18 | A20 |
| 1 | 5.3209E−11 | −1.5646E−12 | 2.0479E−21 | −1.8135E−23 | −4.6543E−25 |
| 2 | −1.6577E−17 | −1.9399E−19 | −2.5347E−21 | −3.5708E−23 | −5.2329E−25 |
| 3 | −1.6263E−10 | 1.8857E−12 | 5.6382E−15 | −6.2500E−16 | −4.9504E−22 |
| 4 | −3.2219E−09 | 2.8228E−11 | −1.6144E−17 | −9.2318E−20 | −5.5466E−22 |
| 5 | −1.7348E−08 | 2.9914E−10 | −3.1647E−17 | −2.1347E−19 | −1.4041E−21 |
| 6 | 5.5334E−09 | −4.8020E−11 | −3.4239E−17 | −2.1530E−19 | −1.4052E−21 |
| 7 | −2.7759E−06 | 1.6103E−07 | −3.3382E−17 | −2.1425E−19 | −1.4052E−21 |
| 8 | 2.0133E−06 | −6.3742E−08 | −2.5313E−21 | −3.5710E−23 | −5.2328E−25 |
| 9 | 7.0907E−06 | −3.2102E−07 | −3.3480E−17 | −2.1485E−19 | −1.4052E−21 |
| 10 | 1.5045E−05 | −6.6901E−07 | −3.3261E−17 | −2.1485E−19 | −1.4052E−21 |
| 11 | −3.8712E−07 | 6.3531E−09 | −8.0348E−18 | −4.2529E−20 | −2.3015E−22 |
| 12 | 1.0276E−07 | −7.2241E−09 | −7.8864E−18 | −4.2526E−20 | −2.3015E−22 |
| 13 | −1.3708E−17 | −1.8190E−19 | −2.4959E−21 | −3.5508E−23 | −5.2213E−25 |
| 14 | −1.3376E−17 | −1.8194E−19 | −2.4951E−21 | −3.5508E−23 | −5.2213E−25 |
| 15 | −1.5361E−17 | −1.8786E−19 | −2.5269E−21 | −3.5615E−23 | −5.2232E−25 |
| 16 | −1.3276E−17 | −1.7658E−19 | −2.5200E−21 | −3.5674E−23 | −5.2233E−25 |
| 17 | −4.6861E−09 | −6.0830E−12 | −4.7490E−17 | −2.0087E−19 | −1.4088E−21 |
| 18 | 6.7332E−10 | −1.0469E−12 | −3.7370E−13 | −2.5665E−19 | −1.4640E−21 |

TABLE 8
Various data (zoom ratio 1.537, image height 4.000)
Various data

| | Wide-angle | Intermediate | Telephoto |
|---|---|---|---|
| Focal length | 3.585 | 4.073 | 5.510 |
| F number | 2.000 | 2.154 | 2.609 |
| Half field of view | 64.967 | 50.969 | 35.509 |
| Total length of lens | 9.800 | 9.532 | 9.265 |
| d6 | 1.774 | 1.268 | 0.300 |
| d18 | 0.424 | 0.662 | 1.364 |

TABLE 9
Data of zoom lens groups

| | | | Configuration | Movement |
|---|---|---|---|---|
| | | | length of | amount of |
| Group | Initial surface | Focal length | lens | lens |
| 1 | 1 | −5.684 | 2.099 | −0.535 |
| 2 | 7 | 2.662 | 5.053 | 0.939 |

TABLE 10
Magnifications of zoom lens groups

| Group | Initial surface | Wide-angle | Intermediate | Telephoto |
|---|---|---|---|---|
| 1 | 1 | 0.000 | 0.000 | 0.000 |
| 2 | 7 | −0.631 | −0.717 | −0.969 |

### Third Embodiment

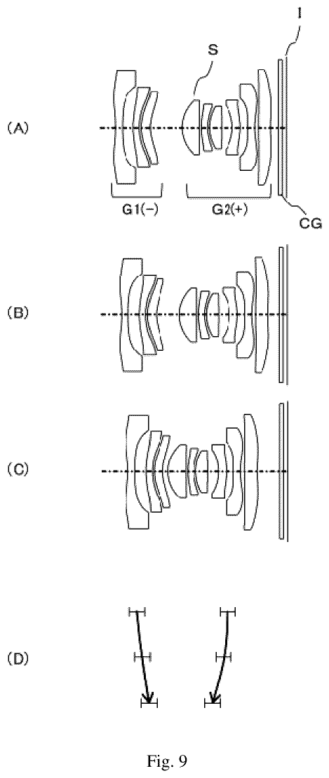

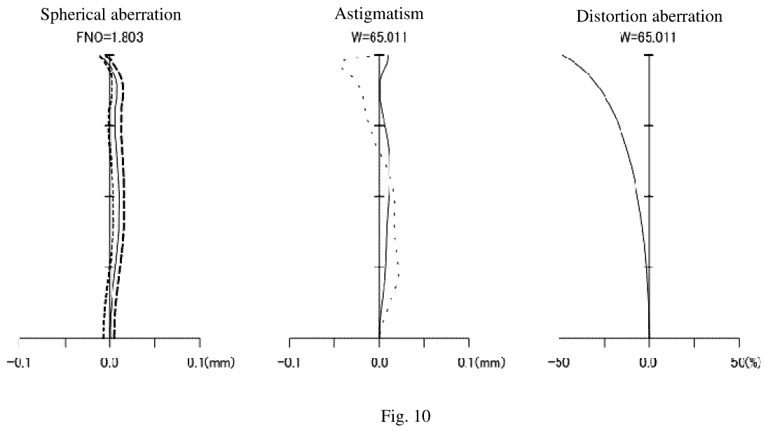

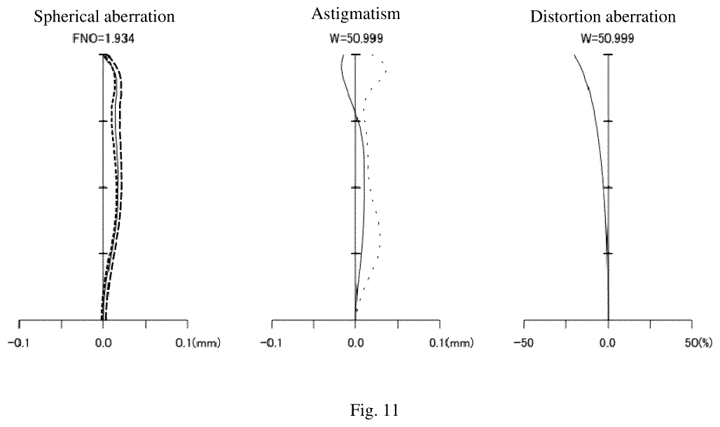

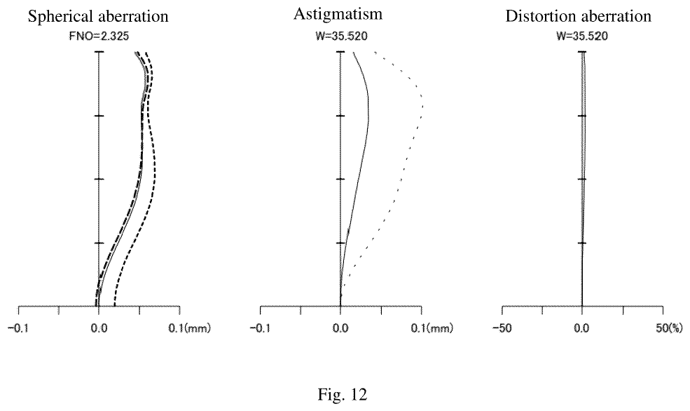

FIG. 9 is a lens layout view showing a wide-angle end state (FIG. 9 (A)), an intermediate focus position state (FIG. 9 (B)) and a telephoto end state (FIG. 9 (C)) of a zoom lens according to an embodiment (third embodiment) of this implementation, and a diagram showing a change of a first lens group G1 and a second lens group G2 from the wide-angle end state to the telephoto end state (FIG. 9 (D)). FIG. 10 is a longitudinal aberration diagram of the wide-angle end state of the third embodiment. FIG. 11 is a longitudinal aberration diagram of the intermediate focus position state of the third embodiment. FIG. 12 is a longitudinal aberration diagram of the telephoto end state of the third embodiment.

The zoom lens in the third embodiment has the first lens group G1 with a negative refractive power and the second lens group G2 with a positive refractive power, and an aperture stop S for adjusting a light quantity is arranged between the first lens group G1 and the second lens group G2. In addition, an optical filter CG including an infrared cut-off filter or the like is arranged between the second lens group G2 and an imaging position I.

In the third embodiment with the above configuration, in a process of zooming from the wide-angle end state to the telephoto end state, the first lens group G1 gradually moves toward an image side and the second lens group G2 gradually moves toward an object side. That is, the first lens group G1 and the second lens group G2 move by different trajectories to reduce an interval therebetween. The aperture stop S moves integrally with the second lens group G2.

In the following tables, values of parameters of the third embodiment are shown.

TABLE 11
Surface data

| Surface | | | | | |
|---|---|---|---|---|---|
| number | r | d | nd | vd | |
| 1* | −6.544 | 0.400 | 1.5731 | 37.65 | |
| 2* | 12.856 | 0.635 | | | |
| 3* | 5.239 | 0.350 | 1.5439 | 55.93 | |
| 4* | 4.034 | 0.100 | | | |
| 5* | 2.424 | 0.500 | 1.6714 | 19.27 | |
| 6* | 2.339 | d6 | | | |
| 7* | 2.005 | 1.030 | 1.5439 | 55.93 | (Aperture stop) |
| 8* | −85.217 | 0.100 | | | |
| 9* | 3.454 | 0.350 | 1.6714 | 19.27 | |
| 10* | 2.276 | 0.117 | | | |
| 11* | 2.310 | 0.687 | 1.5439 | 55.93 | |
| 12* | −21.423 | 0.617 | | | |
| 13* | −2.220 | 0.450 | 1.6714 | 19.27 | |
| 14* | −3.271 | 0.411 | | | |
| 15* | 22.223 | 0.400 | 1.5439 | 55.93 | |
| 16* | 3.697 | 0.228 | | | |
| 17* | 23.873 | 0.723 | 1.6714 | 19.27 | |
| 18* | 10.888 | d18 | | | |
| 19 | ∞ | 0.210 | 1.5168 | 64.17 | |
| 20 | ∞ | 0.240 | | | |

*represents aspheric surface

TABLE 12
Aspheric data (in which an aspheric coefficient not shown is 0.00)

| Surface | | | | | |
|---|---|---|---|---|---|
| number | k | A4 | A6 | A8 | A10 |
| 1 | −5.0000E+00 | 1.5790E−02 | −8.6839E−04 | −1.8002E−05 | 1.7675E−06 |
| 2 | 4.1418E+00 | 1.5194E−03 | 5.3543E−03 | −7.1342E−04 | 5.3664E−05 |
| 3 | −9.0361E−01 | −6.7511E−03 | −6.5881E−04 | −5.5855E−05 | 1.5926E−05 |
| 4 | 8.8630E−01 | 2.1763E−02 | −5.5084E−03 | −7.0385E−04 | 1.2611E−04 |
| 5 | −3.9239E+00 | −1.8608E−03 | 1.5738E−03 | −5.9738E−04 | 7.6401E−06 |
| 6 | −4.4037E+00 | −1.6519E−02 | 2.3754E−03 | −9.4178E−05 | −5.2195E−05 |
| 7 | −2.6326E−01 | 2.0504E−03 | 4.9560E−04 | 1.2474E−04 | 2.9506E−05 |
| 8 | −5.0000E+00 | 5.3745E−03 | 1.5537E−05 | −7.8591E−04 | 1.9773E−04 |
| 9 | −5.0000E+00 | −2.4326E−02 | −1.1077E−03 | −5.8030E−04 | 8.4883E−04 |
| 10 | 1.1954E+00 | −5.9130E−02 | −8.7131E−03 | 4.8541E−03 | −4.7097E−04 |
| 11 | 6.4829E−01 | −8.6422E−03 | −4.8968E−03 | 2.3136E−03 | 2.3963E−04 |
| 12 | 8.9891E−01 | 9.5986E−03 | 2.3960E−03 | −3.7604E−03 | 8.1633E−04 |
| 13 | −1.7023E+00 | 1.1623E−02 | −1.1007E−02 | −1.6681E−03 | −3.1048E−03 |
| 14 | −5.0000E+00 | 3.3542E−02 | 6.2560E−05 | 5.7270E−04 | −2.0160E−04 |
| 15 | 5.0000E+00 | −6.5048E−02 | 1.4451E−03 | 2.0513E−04 | −6.8590E−05 |
| 16 | −5.0000E+00 | −3.7680E−02 | 6.0479E−03 | −7.1703E−04 | 2.6648E−05 |
| 17 | 5.0000E+00 | −8.0646E−03 | 1.2440E−03 | −8.3373E−05 | 1.6720E−06 |
| 18 | 4.5427E+00 | −2.0437E−02 | 1.8420E−03 | −3.4149E−05 | −2.9810E−06 |
| Surface | | | | | |
| number | A12 | A14 | A16 | A18 | A20 |
| 1 | 5.4107E−11 | −1.5644E−12 | 2.4566E−18 | 4.0279E−20 | 6.4565E−22 |
| 2 | 1.0122E−14 | 1.5899E−16 | 2.5551E−18 | 4.0661E−20 | 6.4697E−22 |
| 3 | −1.6262E−10 | 1.8858E−12 | 5.6407E−15 | −6.2496E−16 | 1.5249E−22 |
| 4 | −3.2218E−09 | 2.8228E−11 | −1.3585E−17 | −5.1615E−20 | 9.2840E−23 |
| 5 | −1.7348E−08 | 2.9914E−10 | −2.9089E−17 | −1.7277E−19 | −7.5658E−22 |
| 6 | 5.5344E−09 | −4.8020E−11 | −3.1681E−17 | −1.7460E−19 | −7.5771E−22 |
| 7 | −2.7759E−06 | 1.6103E−07 | −3.0824E−17 | −1.7355E−19 | −7.5767E−22 |
| 8 | 2.0133E−06 | −6.3742E−08 | 2.5556E−18 | 4.0664E−20 | 6.4699E−22 |
| 9 | 7.0907E−06 | −3.2102E−07 | −3.0922E−17 | −1.7415E−19 | −7.5767E−22 |
| 10 | 1.5045E−05 | −6.6901E−07 | −3.0703E−17 | −1.7415E−19 | −7.5767E−22 |
| 11 | −3.8712E−07 | 6.3531E−09 | −5.4766E−18 | −1.8291E−21 | 4.1736E−22 |
| 12 | 1.0276E−07 | −7.2241E−09 | −5.3283E−18 | −1.8264E−21 | 4.1736E−22 |
| 13 | 1.0089E−14 | 1.6060E−16 | 2.5556E−18 | 4.0664E−20 | 6.4699E−22 |
| 14 | 1.0093E−14 | 1.6061E−16 | 2.5556E−18 | 4.0664E−20 | 6.4699E−22 |
| 15 | 8.0347E−15 | 1.2410E−16 | 1.8988E−18 | 2.9040E−20 | 4.4410E−22 |
| 16 | 8.1317E−15 | 1.2404E−16 | 1.8989E−18 | 2.9039E−20 | 4.4408E−22 |
| 17 | −4.6861E−09 | −6.0828E−12 | −4.4931E−17 | −1.6113E−19 | −7.6747E−22 |
| 18 | 6.7333E−10 | −1.0467E−12 | −3.7370E−13 | −2.1496E−19 | −8.1670E−22 |

TABLE 13
Various data (zoom ratio 1.523, image height 4.000)
various data

| | Wide-angle | Intermediate | Telephoto |
|---|---|---|---|
| Focal length | 3.590 | 4.063 | 5.469 |
| F number | 1.803 | 1.934 | 2.325 |
| Half field of view | 65.011 | 50.999 | 35.520 |
| Total length of lens | 9.800 | 9.502 | 9.160 |
| d6 | 1.824 | 1.307 | 0.300 |
| d18 | 0.429 | 0.648 | 1.313 |

TABLE 14
Data of zoom lens group

| | | | Configuration length | Movement amount |
|---|---|---|---|---|
| Group | Intial surface | Focal length | of lens | of lens |
| 1 | 1 | −5.990 | 1.985 | −0.640 |
| 2 | 7 | 2.658 | 5.112 | 0.884 |

TABLE 15
Magnifications of zoom lens groups

| Group | Initial surface | Wide-angle | Intermediate | Telephoto |
|---|---|---|---|---|
| 1 | 1 | 0.000 | 0.000 | 0.000 |
| 2 | 7 | 0.599 | 0.678 | −0.913 |

### Fourth Embodiment

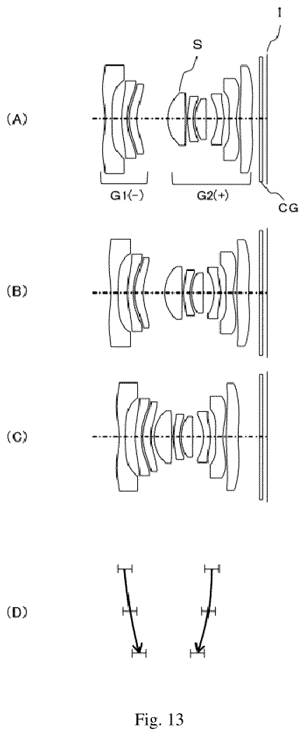

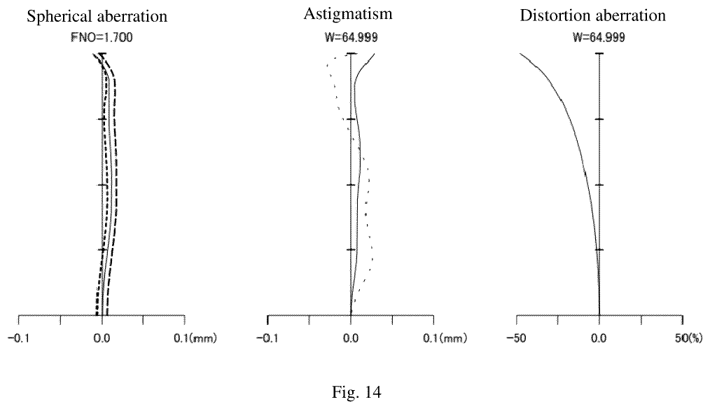

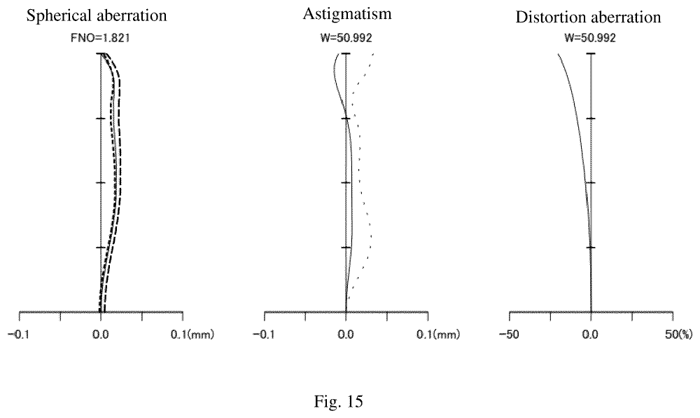

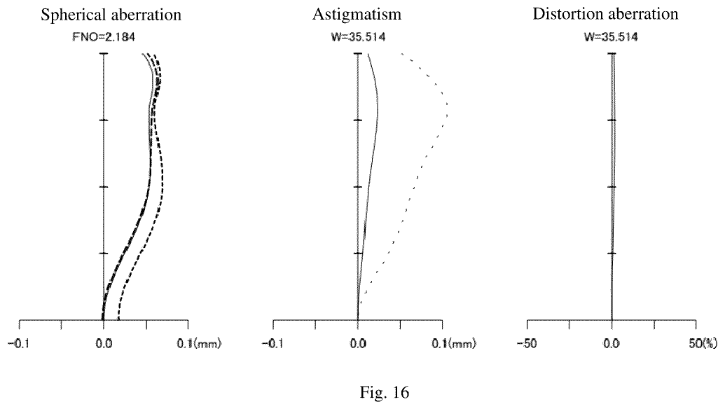

FIG. 13 is a lens layout view showing a wide-angle end state (FIG. 13 (A)), an intermediate focus position state (FIG. 13 (B)) and a telephoto end state (FIG. 13 (C)) of a zoom lens according to an embodiment (fourth embodiment) of this implementation, and a diagram showing a change of a first lens group G1 and a second lens group G2 from the wide-angle end state to the telephoto end state (FIG. 13 (D)). FIG. 14 is a longitudinal aberration diagram of the wide-angle end state of the fourth embodiment. FIG. 15 is a longitudinal aberration diagram of the intermediate focus position state of the fourth embodiment. FIG. 16 is a longitudinal aberration diagram of the telephoto end state of the fourth embodiment.

The zoom lens in the fourth embodiment has the first lens group G1 with a negative refractive power and the second lens group G2 with a positive refractive power, and an aperture stop S for adjusting a light quantity is arranged between the first lens group G1 and the second lens group G2. In addition, an optical filter CG including an infrared cut-off filter or the like is arranged between the second lens group G2 and an imaging position I.

In the fourth embodiment with the above configuration, in a process of zooming from the wide-angle end state to the telephoto end state, the first lens group G1 gradually moves toward an image side and the second lens group G2 gradually moves toward an object side. That is, the first lens group G1 and the second lens group G2 move by different trajectories to reduce an interval therebetween. The aperture stop S moves integrally with the second lens group G2.

In the following tables, values of parameters of the fourth embodiment are shown.

TABLE 16
Surface data

| Surface number | r | d | nd | νd | |
|---|---|---|---|---|---|
| 1* | −5.798 | 0.424 | 1.5740 | 37.90 | |
| 2* | 19.458 | 0.606 | | | |
| 3* | 5.455 | 0.350 | 1.5445 | 55.96 | |
| 4* | 4.240 | 0.100 | | | |
| 5* | 2.624 | 0.500 | 1.6714 | 19.27 | |
| 6* | 2.585 | d6 | | | |
| 7* | 2.097 | 1.110 | 1.5452 | 55.26 | (Aperture stop) |
| 8* | −35.445 | 0.100 | | | |
| 9* | 3.681 | 0.366 | 1.6714 | 19.27 | |
| 10* | 2.248 | 0.119 | | | |
| 11* | 2.317 | 0.697 | 1.5445 | 55.96 | |
| 12* | −44.377 | 0.680 | | | |
| 13* | −2.092 | 0.400 | 1.6494 | 20.87 | |
| 14* | −2.731 | 0.343 | | | |
| 15* | 8.657 | 0.438 | 1.5488 | 50.78 | |
| 16* | 3.139 | 0.236 | | | |
| 17* | 16.975 | 0.731 | 1.6653 | 19.99 | |
| 18* | 8.816 | d18 | | | |
| 29 | ∞ | 0.210 | 1.5168 | 64.17 | |
| 20 | ∞ | 0.240 | | | |

*resents aspheric surface

TABLE 17
Aspheric data (in which an aspheric coefficient not shown is 0.00)

| Surface | | | | | |
|---|---|---|---|---|---|
| number | k | A4 | A6 | A8 | A10 |
| 1 | −4.6486E+00 | 1.4913E−02 | −8.0592E−04 | −1.2938E−05 | 1.3803E−06 |
| 2 | 4.9642E+00 | 2.5094E−03 | 4.7113E−03 | −5.8241E−04 | 4.0734E−05 |
| 3 | −4.9870E−01 | −6.0299E−03 | −5.1984E−04 | −5.2733E−05 | 1.1342E−05 |
| 4 | 6.6665E−01 | 2.0148E−02 | −4.9182E−03 | −5.6069E−04 | 1.0048E−04 |
| 5 | −4.2916E+00 | −1.7459E−03 | 1.3919E−03 | −5.3045E−04 | 1.7592E−05 |
| 6 | −4.7080E+00 | −1.5655E−02 | 2.1794E−03 | −5.8966E−05 | −4.0095E−05 |
| 7 | −2.7494E−01 | 1.7980E−03 | 4.4795E−04 | 1.1021E−04 | 5.2973E−06 |
| 8 | 5.0000E+00 | 4.2231E−03 | −2.9541E−04 | −6.2406E−04 | 1.8077E−04 |
| 9 | −4.9702E+00 | −2.5064E−02 | −5.0243E−04 | −4.3309E−04 | 7.0835E−04 |
| 10 | 1.1500E+00 | −5.5465E−02 | −8.3504E−03 | 3.6611E−03 | −4.8399E−04 |
| 11 | 6.2275E−01 | −6.8510E−03 | −5.3124E−03 | 1.8052E−03 | −4.2906E−05 |
| 12 | −5.0000E+00 | 8.4577E−03 | 3.5751E−03 | −2.8568E−03 | 2.5557E−04 |
| 13 | −2.5309E+00 | 1.7479E−02 | −7.9709E−03 | −1.4059E−03 | −1.5259E−03 |
| 14 | −4.9956E+00 | 3.4382E−02 | 2.9177E−04 | 6.4487E−04 | −1.6781E−04 |
| 15 | 3.4418E−01 | −6.6428E−02 | 1.7928E−03 | 2.4074E−04 | −5.6437E−05 |
| 16 | −5.0000E+00 | −3.5727E−02 | 5.9616E−03 | −6.8796E−04 | 2.2165E−05 |
| 17 | 3.8375E+00 | −6.0821E−03 | 9.0108E−04 | −8.3569E−05 | 2.4987E−06 |
| 18 | 1.8382E+00 | −1.9625E−02 | 1.7102E−03 | −3.5077E−05 | −2.5656E−06 |
| Surface | | | | | |
| number | A12 | A14 | A16 | A18 | A20 |
| 1 | 4.3544E−11 | −1.2093E−12 | 1.8358E−18 | 2.8117E−20 | 4.3579E−22 |
| 2 | 7.4460E−15 | 1.1830E−16 | 1.8445E−18 | 2.8407E−20 | 4.3671E−22 |
| 3 | −1.3079E−10 | 1.4578E−12 | 4.1911E−15 | −4.4632E−16 | 9.7285E−23 |
| 4 | −2.5912E−09 | 2.1821E−11 | −1.0148E−17 | −3.7493E−20 | 5.6339E−23 |
| 5 | −1.3952E−08 | 2.3124E−10 | −2.1672E−17 | −1.2401E−19 | −5.3747E−22 |
| 6 | 4.4503E−09 | −3.7121E−11 | −2.3594E−17 | −1.2533E−19 | −5.2751E−22 |
| 7 | −2.2326E−06 | 1.2448E−07 | −2.2957E−17 | −1.2457E−19 | −5.2748E−22 |
| 8 | 1.6193E−06 | −4.9274E−08 | 1.8448E−18 | 2.8409E−20 | 4.3672E−22 |
| 9 | 5.7023E−06 | −2.4816E−07 | −2.3030E−17 | −1.2500E−19 | −5.2748E−22 |
| 10 | 1.2100E−05 | −5.1717E−07 | −2.2867E−17 | −1.2500E−19 | −5.2748E−22 |
| 11 | −3.1134E−07 | 4.9111E−09 | −4.1233E−18 | −1.9384E−21 | 2.7910E−22 |
| 12 | 8.2649E−08 | −5.5845E−09 | −4.0131E−18 | −1.9365E−21 | 2.7910E−22 |
| 13 | 7.7180E−15 | 1.1952E−16 | 1.8448E−18 | 2.8409E−20 | 4.3672E−22 |
| 14 | 7.7242E−15 | 1.1953E−16 | 1.8448E−18 | 2.8409E−20 | 4.3672E−22 |
| 15 | 6.0648E−15 | 9.1296E−17 | 1.3567E−18 | 2.0107E−20 | 2.9745E−22 |
| 16 | 9.0140E−15 | 9.1357E−17 | 1.3571E−18 | 2.0112E−20 | 2.9747E−22 |
| 17 | −3.7689E−09 | −4.7023E−12 | −3.3444E−17 | −1.1571E−19 | −5.3421E−22 |
| 18 | 5.4161E−10 | −8.0903E−13 | −2.7766E−13 | −1.5414E−19 | −5.6799E−22 |

TABLE 18
Various data (zoom ratio 1.525, image height 4.000)
(Table 18) Various data

| | Wide-angle | Intermediate | Telephoto |
|---|---|---|---|
| Focal length | 3.589 | 4.059 | 5.473 |
| F number | 1.700 | 1.821 | 2.184 |
| Half field of view | 64.999 | 50.992 | 35.514 |
| Total length of lens | 10.000 | 9.637 | 9.156 |
| d6 | 1.901 | 1.328 | 0.200 |
| d18 | 0.450 | 0.659 | 1.307 |

TABLE 19
Data of zoom lens groups
(Table 19) Data of zoom lens groups

| | | | Configuration length | Movement amount |
|---|---|---|---|---|
| Group | Initial surface | Focal length | of lens | of lens |
| 1 | 1 | −6.414 | 1.980 | −0.844 |
| 2 | 7 | 2.784 | 5.219 | 0.857 |

TABLE 20
Magnifications of zoom lens groups

| Group | Initial surface | Wide-angle | Intermediate | Telephoto |
|---|---|---|---|---|
| 1 | 1 | 0.000 | 0.000 | 0.000 |
| 2 | 7 | −0.560 | −0.633 | −0.853 |

### Fifth Embodiment

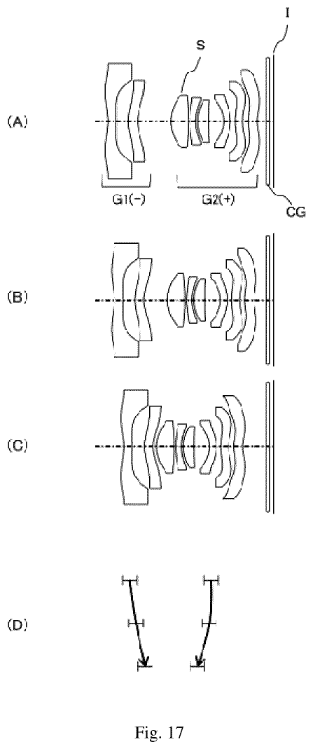

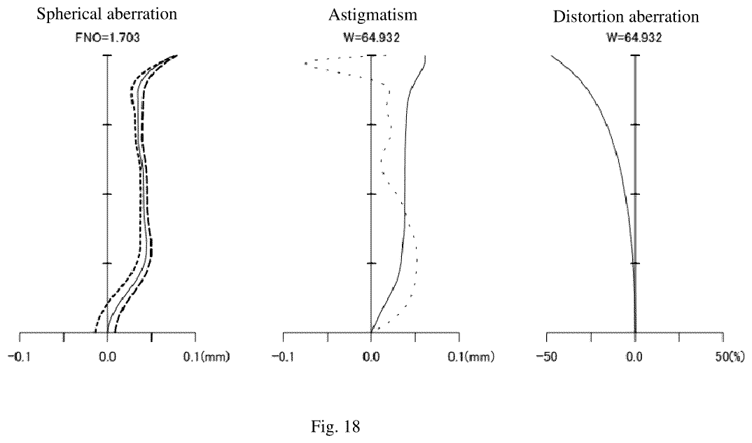

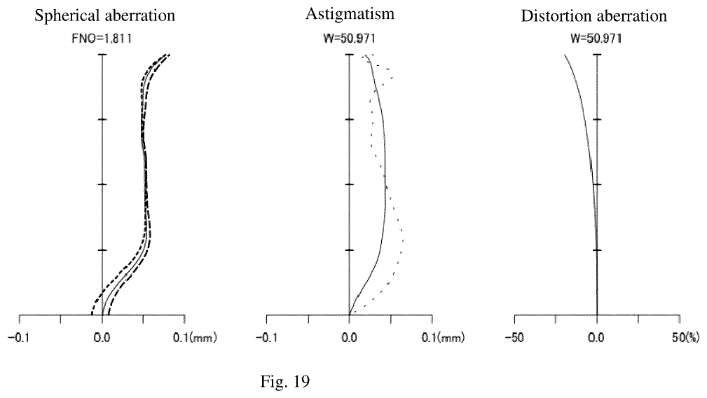

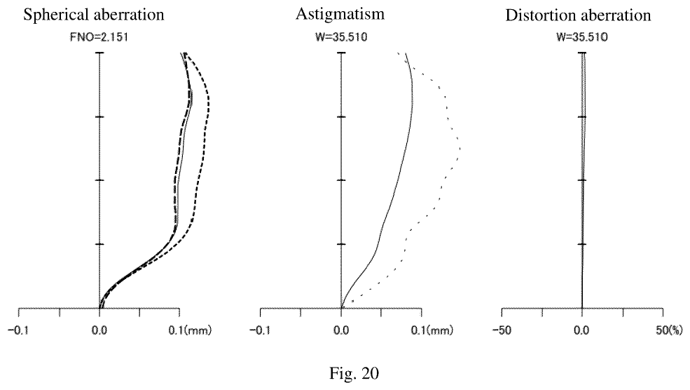

FIG. 17 is a lens layout view showing a wide-angle end state (FIG. 17 (A)), an intermediate focus position state (FIG. 17 (B)) and a telephoto end state (FIG. 17 (C)) of a zoom lens according to an embodiment (fifth embodiment) of this implementation and a change of a first lens group G1 and a second lens group G2 from the wide-angle end state to the telephoto end state (FIG. 17 (D)). FIG. 18 is a longitudinal aberration diagram of the wide-angle end state of the fifth embodiment. FIG. 19 is a longitudinal aberration diagram of the intermediate focus position state of the fifth embodiment. FIG. 20 is a longitudinal aberration diagram of the telephoto end state of the fifth embodiment.

The zoom lens in the fifth embodiment has the first lens group G1 with a negative refractive power and the second lens group G2 with a positive refractive power, and an aperture stop S for adjusting a light quantity is arranged between the first lens group G1 and the second lens group G2. In addition, an optical filter CG including an infrared cut-off filter or the like is arranged between the second lens group G2 and an imaging position I.

In the fifth embodiment with the above configuration, in a process of zooming from the wide-angle end state to the telephoto end state, the first lens group G1 gradually moves toward an image side and a second lens group G2 gradually moves toward an object side. That is, the first lens group G1 and the second lens group G2 move by different trajectories to reduce an interval therebetween. The aperture stop S moves integrally with the second lens group G2.

In the following tables, values of parameters of the fifth embodiment are shown.

TABLE 21
Surface data

| Surface number | r | d | nd | νd | |
|---|---|---|---|---|---|
| 1* | −3.839 | 0.516 | 1.5439 | 55.93 | |
| 2* | −16.153 | 0.736 | | | |
| 3* | 2.515 | 0.535 | 1.5439 | 55.93 | |
| 4* | 2.045 | d4 | | | |
| 5* | 2.237 | 1.044 | 1.5439 | 55.93 | (Aperture stop) |
| 6* | −22.133 | 0.100 | | | |
| 7* | 3.748 | 0.350 | 1.6714 | 19.27 | |
| 8* | 2.242 | 0.110 | | | |
| 9* | 2.321 | 0.666 | 1.5439 | 55.93 | |
| 10* | 49.222 | 0.918 | | | |
| 11* | −1.639 | 0.400 | 1.6161 | 25.78 | |
| 12* | −2.219 | 0.297 | | | |
| 13* | 5.207 | 0.457 | 1.5439 | 55.93 | |
| 14* | 2.868 | 0.322 | | | |
| 15* | 2.268 | 0.560 | 1.5439 | 55.93 | |
| 16* | 2.219 | d16 | | | |
| 17 | ∞ | 0.210 | 1.5168 | 64.17 | |
| 18 | ∞ | 0.240 | | | |

*represents aspheric surface

TABLE 22
Aspheric data (in which an aspheric coefficient not shown is 0.00)

| Surface | | | | | |
|---|---|---|---|---|---|
| number | k | A4 | A6 | A8 | A10 |
| 1 | −4.8486E+00 | 3.2501E−02 | −6.6747E−03 | 1.2406E−03 | −1.9859E−04 |
| 2 | 1.7818E+00 | 2.6198E−02 | 3.5781E−03 | −2.2298E−03 | 7.2917E−04 |
| 3 | −5.0000E+00 | −3.7634E−02 | 7.6720E−03 | 3.4625E−04 | −5.4831E−04 |
| 4 | −4.4405E+00 | −2.1911E−02 | −5.4695E−03 | 1.1227E−02 | −7.4993E−03 |
| 5 | −3.8396E−01 | −7.8671E−04 | 1.2762E−02 | −3.2286E−02 | 4.7226E−02 |
| 6 | 5.0000E+00 | −4.6615E−02 | 7.9948E−02 | −8.3723E−02 | 5.3091E−02 |
| 7 | −3.6195E+00 | −9.2347E−02 | 1.2200E−01 | −1.5758E−01 | 1.6647E−01 |
| 8 | 7.4306E−01 | −8.1342E−02 | 4.0317E−02 | −1.7947E−02 | −2.4987E−02 |
| 9 | 4.9260E−01 | −1.4753E−02 | 3.4554E−02 | −9.5921E−02 | 1.6027E−01 |
| 10 | −5.0000E+00 | 1.5748E−02 | −2.1461E−02 | 6.2892E−02 | −1.0744E−01 |
| 11 | −1.2481E+00 | 5.8130E−03 | −2.3944E−04 | −2.1395E−01 | 5.6562E−01 |
| 12 | −4.2134E+00 | 7.5953E−02 | −2.4897E−01 | 3.2149E−01 | −2.4706E−01 |
| 13 | −3.5084E+00 | 1.2022E−01 | −2.8185E−01 | 2.7694E−01 | −1.7987E−01 |
| 14 | −1.0531E−01 | −2.2209E−02 | −5.2171E−02 | 4.3535E−02 | −2.2308E−02 |
| 15 | −3.9094E+00 | −1.6191E−01 | 6.6162E−02 | −1.7259E−02 | 2.0576E−03 |
| 16 | −4.3302E+00 | −1.1687E−01 | 5.0031E−02 | −1.6462E−02 | 4.0212E−03 |
| Surface | | | | | |
| number | A12 | A14 | A16 | A18 | A20 |
| 1 | 2.5684E−05 | −2.6005E−06 | 1.8324E−07 | −7.5868E−09 | 1.3599E−10 |
| 2 | −1.5260E−04 | 2.8751E−05 | −4.3454E−06 | 3.6073E−07 | −1.1583E−08 |
| 3 | 9.8281E−05 | −1.5291E−06 | −1.4863E−06 | 1.7782E−07 | −6.5259E−09 |
| 4 | 2.9151E−03 | −7.1631E−04 | 1.1011E−04 | −9.6744E−06 | 3.7072E−07 |
| 5 | −4.2515E−02 | 2.3891E−02 | −8.1884E−03 | 1.5652E−03 | −1.2773E−04 |
| 6 | −1.5988E−02 | −2.0580E−03 | 3.4188E−03 | −1.0649E−03 | 1.1577E−04 |
| 7 | −1.2826E−01 | 6.7872E−02 | −2.2988E−02 | 4.4596E−03 | −3.7607E−04 |
| 8 | 6.4104E−02 | −6.4268E−02 | 3.4969E−02 | −1.0046E−02 | 1.1905E−03 |
| 9 | −1.7083E−01 | 1.1711E−01 | −4.9996E−02 | 1.2076E−02 | −1.2553E−03 |
| 10 | 1.0825E−01 | −6.6425E−02 | 2.3710E−02 | −4.4715E−03 | 3.4305E−04 |
| 11 | −7.2837E−01 | 5.4972E−01 | −2.4699E−01 | 6.0848E−02 | −6.2962E−03 |
| 12 | 1.2827E−01 | −4.4516E−02 | 9.7850E−03 | −1.2198E−03 | 6.5203E−05 |
| 13 | 7.7618E−02 | −2.1720E−02 | 3.7183E−03 | −3.4896E−04 | 1.3649E−05 |
| 14 | 7.4738E−03 | −1.6341E−03 | 2.2260E−04 | −1.6937E−05 | 5.4418E−07 |
| 15 | 2.3288E−04 | −1.1649E−04 | 1.6391E−05 | −1.0600E−06 | 2.6777E−08 |
| 16 | −6.7568E−04 | 7.4064E−05 | −5.0120E−06 | 1.8836E−07 | −2.9871E−09 |

TABLE 23
Various data (zoom ratio 1.513, image height 4.000)
(Table 23) Various data

| | Wide-angle | Intermediate | Telephoto |
|---|---|---|---|
| Focal length | 3.582 | 4.025 | 5.418 |
| F number | 1.703 | 1.811 | 2.151 |
| Hal field of view | 64.932 | 50.971 | 35.510 |
| Total length of lens | 10.000 | 9.612 | 9.047 |
| d4 | 2.014 | 1.425 | 0.200 |
| d16 | 0.524 | 0.725 | 1.385 |

TABLE 24
Data of zoom lens groups

| | | | Configuration | Movement |
|---|---|---|---|---|
| | Initial | Focal | length | amount |
| Group | surface | length | of lens | of lens |
| 1 | 1 | −6.680 | 1.787 | −0.953 |
| 2 | 5 | 2.869 | 5.225 | 0.861 |

TABLE 25
Magnifications of zoom lens groups

| Group | Initial surface | Wide-angle | Intermediate | Telephoto |
|---|---|---|---|---|
| 1 | 1 | 0.000 | 0.000 | 0.000 |
| 2 | 5 | −0.536 | −0.602 | −0.811 |

### Sixth Embodiment

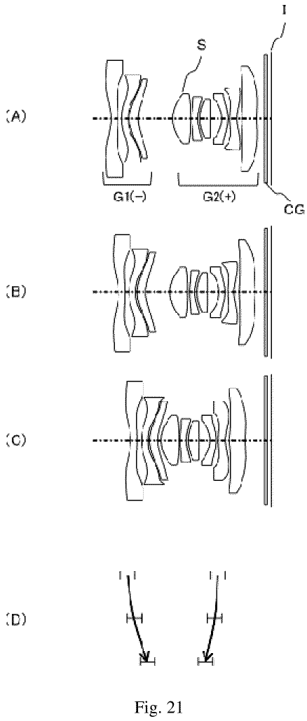

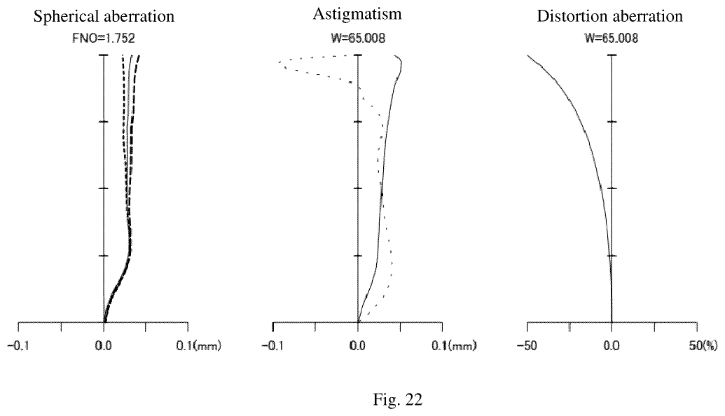

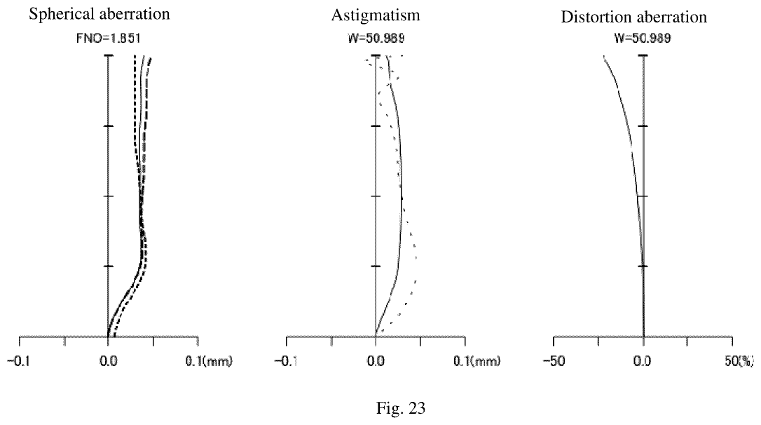

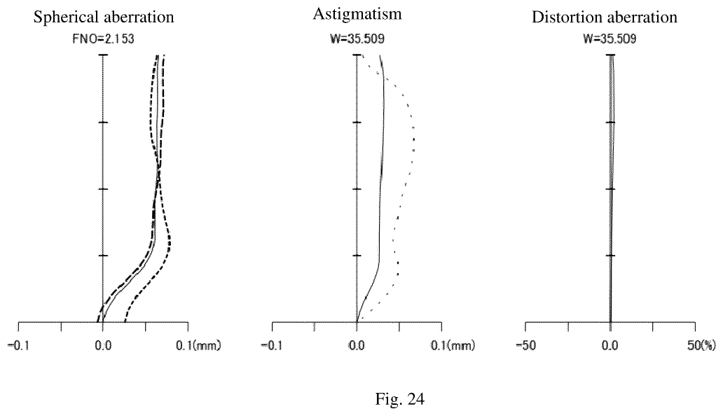

FIG. 21 is a lens layout view showing a wide-angle end state (FIG. 21 (A)), an intermediate focus position state (FIG. 21 (B)) and a telephoto end state (FIG. 21 (C)) of a zoom lens according to an embodiment (sixth embodiment) of this implementation, and a diagram showing a change of a first lens group G1 and a second lens group G2 from the wide-angle end state to the telephoto end state (FIG. 21 (D)). FIG. 22 is a longitudinal aberration diagram of the wide-angle end state of the sixth embodiment. FIG. 23 is a longitudinal aberration diagram of the intermediate focus position state of the sixth embodiment. FIG. 24 is a longitudinal aberration diagram of the telephoto end state of the sixth embodiment.

The zoom lens in the sixth embodiment has the first lens group G1 with a negative refractive power and the second lens group G2 with a positive refractive power, and an aperture stop S for adjusting a light quantity is arranged between the first lens group G1 and the second lens group G2. In addition, an optical filter CG including an infrared cut-off filter or the like is arranged between the second lens group G2 and an imaging position I.

In the sixth embodiment with the above configuration, in a process of zooming from the wide-angle end state to the telephoto end state, the first lens group G1 gradually moves toward an image side and the second lens group G2 gradually moves toward an object side. That is, the first lens group G1 and the second lens group G2 move by different trajectories to reduce an interval therebetween. The aperture stop S moves integrally with the second lens group G2.

In the following tables, values of parameters of the sixth embodiment are shown.

TABLE 26
Surface data

| Surface number | r | d | nd | νd | |
|---|---|---|---|---|---|
| 1* | −2.897 | 0.400 | 1.5731 | 37.65 | |
| 2* | −10.666 | 0.255 | | | |
| 3* | 3.417 | 0.383 | 1.5439 | 55.93 | |
| 4* | 3.874 | 0.100 | | | |
| 5* | 2.259 | 0.500 | 1.6714 | 19.27 | |
| 6* | 2.051 | d6 | | | |
| 7* | 1.995 | 1.061 | 1.5439 | 55.93 | (Aperture stop) |
| 8* | −17.385 | 0.100 | | | |
| 9* | 3.618 | 0.350 | 1.6714 | 19.27 | |
| 10* | 2.063 | 0.122 | | | |
| 11* | 2.389 | 0.655 | 1.5439 | 55.93 | |
| 12* | −28.147 | 0.674 | | | |
| 13* | −1.519 | 0.350 | 1.6362 | 23.91 | |
| 14* | −2.120 | 0.164 | | | |
| 15* | 8.071 | 0.400 | 1.5439 | 55.93 | |
| 16* | 2.353 | 0.295 | | | |
| 17* | 4.853 | 0.932 | 1.6714 | 19.27 | |
| 18* | 7.787 | d18 | | | |
| 19 | ∞ | 0.210 | 1.5168 | 64.17 | |
| 20 | ∞ | 0.240 | | | |

*represents aspheric surface

TABLE 27
Aspheric data (in which an aspheric coefficient not shown is 0.00)

| Surface | | | | | |
|---|---|---|---|---|---|
| number | k | A4 | A6 | A8 | A10 |
| 1 | −4.8800E+00 | 2.4941E−02 | −4.2099E−03 | 3.9177E−04 | 2.6186E−05 |
| 2 | −3.0958E+00 | 6.9506E−03 | 5.0143E−03 | −8.0375E−04 | −3.7628E−04 |
| 3 | −4.9570E+00 | 6.5975E−02 | −4.2899E−02 | −7.5536E−04 | 9.0143E−03 |
| 4 | 1.9793E−01 | 1.7140E−01 | −1.1639E−01 | 3.9635E−02 | −9.2017E−03 |
| 5 | −3.9997E+00 | 3.8207E−02 | −4.7928E−02 | 4.9212E−02 | −3.2886E−02 |
| 6 | −4.9479E+00 | −1.8800E−02 | 2.7585E−03 | 6.7502E−03 | −8.9137E−03 |
| 7 | −4.3761E−01 | 3.2087E−03 | 8.5479E−03 | −2.3687E−02 | 3.8146E−02 |
| 8 | 5.0000E+00 | −3.2081E−02 | 8.3728E−02 | −1.4365E−01 | 1.6332E−01 |
| 9 | −5.0000E+00 | −1.0337E−01 | 1.4084E−01 | −2.5642E−01 | 3.5279E−01 |
| 10 | −1.9060E−01 | −1.0628E−01 | 6.2887E−02 | 1.0984E−02 | −2.4641E−01 |
| 11 | 6.3871E−01 | −1.9363E−02 | 5.8485E−02 | −1.5449E−01 | 2.9190E−01 |
| 12 | −5.0000E+00 | 1.2263E−02 | −6.0340E−02 | 2.9255E−01 | −7.4838E−01 |
| 13 | −7.5323E−01 | 3.8724E−02 | 2.1640E−02 | −3.9188E−01 | 1.2066E+00 |
| 14 | −5.0000E+00 | 1.4280E−01 | −3.7757E−01 | 5.7853E−01 | −5.5747E−01 |
| 15 | 2.0937E+00 | 1.1041E−01 | −4.1208E−01 | 5.8207E−01 | −5.6779E−01 |
| 16 | −4.9939E+00 | −5.1548E−02 | 9.8842E−03 | −1.4328E−03 | 6.9192E−04 |
| 17 | −2.0290E+00 | −8.7437E−02 | 4.6255E−02 | −1.6261E−02 | 4.1149E−03 |
| 18 | −3.1978E+00 | −4.8031E−02 | 1.2669E−02 | −1.9208E−03 | −6.3319E−05 |
| Surface | | | | | |
| number | A12 | A14 | A16 | A18 | A20 |
| 1 | −1.3887E−05 | 1.9099E−06 | −1.3458E−07 | 4.9490E−09 | −7.5283E−11 |
| 2 | 2.2382E−04 | −5.0429E−05 | 5.7480E−06 | −3.2953E−07 | 7.6211E−09 |
| 3 | −4.0715E−03 | 9.0713E−04 | −1.1322E−04 | 7.5884E−06 | −2.1376E−07 |
| 4 | 1.2936E−03 | 1.2662E−06 | −3.8848E−05 | 6.2533E−06 | −3.2129E−07 |
| 5 | 1.2684E−02 | −2.8044E−03 | 3.4426E−04 | −2.1089E−05 | 4.7179E−07 |
| 6 | 5.0501E−03 | −1.5349E−03 | 2.6087E−04 | −2.3711E−05 | 9.9122E−07 |
| 7 | −3.8094E−02 | 2.3530E−02 | −8.8450E−03 | 1.8395E−03 | −1.6444E−04 |
| 8 | −1.2918E−01 | 6.9414E−02 | −2.4149E−02 | 4.8988E−03 | −4.4005E−04 |
| 9 | −3.4487E−01 | 2.3305E−01 | −1.0152E−01 | 2.5529E−02 | −2.8094E−03 |
| 10 | 5.1967E−01 | −5.6367E−01 | 3.5406E−01 | −1.2149E−01 | 1.7706E−02 |
| 11 | −3.9842E−01 | 3.5886E−01 | −1.9913E−01 | 6.1082E−02 | −7.7457E−03 |
| 12 | 1.1703E+00 | −1.1567E+00 | 6.9788E−01 | −2.3587E−01 | 3.4574E−02 |
| 13 | −1.9787E+00 | 1.9312E+00 | −1.1335E+00 | 3.6811E−01 | −5.0402E−02 |
| 14 | 3.6392E−01 | −1.6100E−01 | 4.6017E−02 | −7.5675E−03 | 5.3547E−04 |
| 15 | 3.8577E−01 | −1.7817E−01 | 5.3122E−02 | −9.2062E−03 | 7.0336E−04 |
| 16 | −4.6744E−04 | 1.5009E−04 | −2.4571E−05 | 1.9999E−06 | −6.4211E−08 |
| 17 | −7.8846E−04 | 1.1158E−04 | −1.0640E−05 | 5.9073E−07 | −1.4143E−08 |
| 18 | 1.0994E−04 | −2.6225E−05 | 3.1276E−06 | −1.9199E−07 | 4.8059E−09 |

TABLE 28
Various data (zoom ratio 1.471, image height 4.000)
(Table 28) Various data

| | Wide-angle | Intermediate | Telephoto |
|---|---|---|---|
| Focal length | 3.727 | 4.157 | 5.482 |
| F number | 1.752 | 1.851 | 2.153 |
| Half field of view | 65.008 | 50.989 | 35.509 |
| Total length of lens | 9.699 | 9.263 | 8.530 |
| d6 | 2.084 | 1.474 | 0.200 |
| d18 | 0.424 | 0.597 | 1.138 |

TABLE 29
Data of zoom lens groups

| | | | Configuration length | Movement amount |
|---|---|---|---|---|
| Group | Initial surface | Focal length | of lens | of lens |
| 1 | 1 | −7.526 | 1.638 | −1.170 |
| 2 | 7 | 2.913 | 5.104 | 0.714 |

TABLE 30
Magnifications of zoom lens groups

| Group | Initial surface | Wide-angle | Intermediate | Telephoto |
|---|---|---|---|---|
| 1 | 1 | 0.000 | 0.000 | 0.000 |
| 2 | 7 | −0.495 | −0.552 | −0.728 |

### Seventh Embodiment

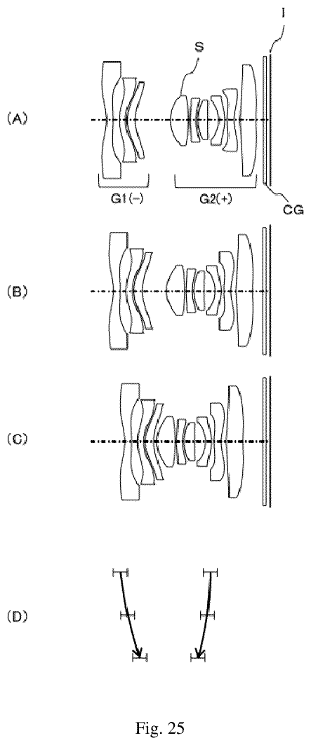

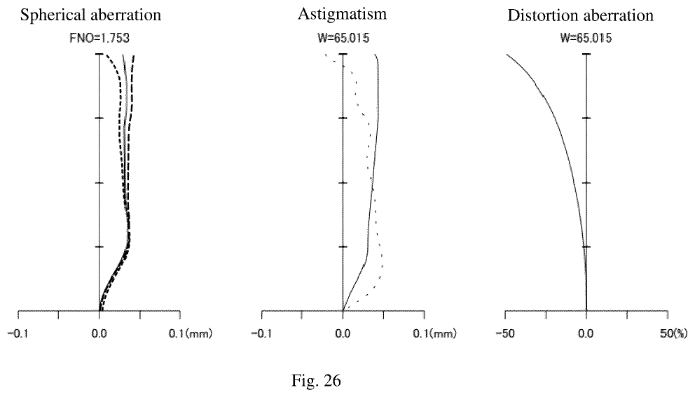

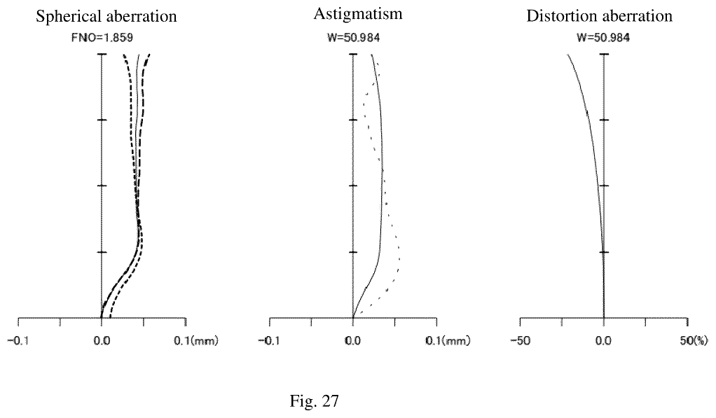

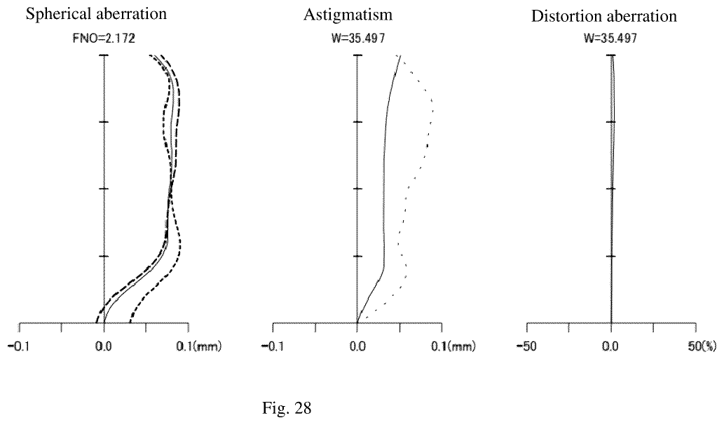

FIG. 25 is a lens layout view showing a wide-angle end state (FIG. 25 (A)), an intermediate focus position state (FIG. 25 (B)) and a telephoto end state (FIG. 25 (C)) of a zoom lens according to an embodiment (seventh embodiment) of this implementation, and a diagram showing a change of a first lens group G1 and a second lens group G2 from the wide-angle end state to the telephoto end state (FIG. 25 (D)). FIG. 26 is a longitudinal aberration diagram of the wide-angle end state of the seventh embodiment. FIG. 27 is a longitudinal aberration diagram of the intermediate focus position state of the seventh embodiment. FIG. 28 is a longitudinal aberration diagram of the telephoto end state of the seventh embodiment.

The zoom lens in the seventh embodiment has the first lens group G1 with a negative refractive power and the second lens group G2 with a positive refractive power, and an aperture stop S for adjusting a light quantity is arranged between the first lens group G1 and the second lens group G2. In addition, an optical filter CG including an infrared cut-off filter or the like is arranged between the second lens group G2 and an imaging position I.

In the seventh embodiment with the above configuration, in a process of zooming from the wide-angle end state to the telephoto end state, the first lens group G1 gradually moves toward an image side and the second lens group G2 gradually moves toward an object side. That is, the first lens group G1 and the second lens group G2 move by different trajectories to reduce an interval. The aperture stop S moves integrally with the second lens group G2.

In the following tables, values of parameters of the seventh embodiment are shown.

TABLE 31
Surface data

| Surface | | | | | |
|---|---|---|---|---|---|
| number | r | d | nd | νd | |
| 1* | −2.772 | 0.400 | 1.5731 | 37.65 | |
| 2* | −8.673 | 0.373 | | | |
| 3* | 3.631 | 0.376 | 1.5439 | 55.93 | |
| 4* | 4.015 | 0.103 | | | |
| 5* | 2.479 | 0.500 | 1.6714 | 19.27 | |
| 6* | 2.227 | d6 | | | |
| 7* | 2.018 | 1.109 | 1.5439 | 55.93 | (Aperture stop) |
| 8* | −15.904 | 0.100 | | | |
| 9* | 3.802 | 0.350 | 1.6714 | 19.27 | |
| 10* | 2.160 | 0.111 | | | |
| 11* | 2.413 | 0.634 | 1.5439 | 55.93 | |
| 12* | −59.399 | 0.671 | | | |
| 13* | −1.487 | 0.350 | 1.6362 | 23.91 | |
| 14* | −2.080 | 0.167 | | | |
| 15* | 5.533 | 0.405 | 1.5439 | 55.93 | |
| 16* | 2.180 | 0.357 | | | |
| 17* | 5.266 | 0.987 | 1.6714 | 19.27 | |
| 18* | 9.240 | d18 | | | |
| 19 | ∞ | 0.210 | 1.5168 | 64.17 | |
| 20 | ∞ | 0.240 | | | |

*represents aspheric surface

TABLE 32
Aspheric data (in which an aspheric coefficient not shown is 0.00)

| Surface | | | | | |
|---|---|---|---|---|---|
| number | k | A4 | A6 | A8 | A10 |
| 1 | −4.4120E+00 | 3.0564E−02 | −7.8221E−03 | 1.9303E−03 | −3.6845E−04 |
| 2 | −5.0000E+00 | 2.3480E−02 | −3.9119E−03 | 2.5908E−03 | −1.1499E−03 |
| 3 | −5.0000E+00 | 6.9482E−02 | −6.1052E−02 | 1.6617E−02 | 2.1321E−03 |
| 4 | −1.0619E−01 | 2.1256E−01 | −2.2292E−01 | 1.5540E−01 | −8.1140E−02 |
| 5 | −3.4686E+00 | 7.9077E−02 | −1.2446E−01 | 1.3175E−01 | −8.9402E−02 |
| 6 | −4.3033E+00 | −1.4597E−02 | −1.0956E−02 | 3.1083E−02 | −3.2085E−02 |
| 7 | −4.6510E−01 | 4.2210E−03 | 4.7109E−03 | −1.3181E−02 | 2.1037E−02 |
| 8 | 5.0000E+00 | −4.9600E−02 | 1.1156E−01 | −1.7595E−01 | 1.8981E−01 |
| 9 | −5.0000E+00 | −1.2527E−01 | 1.6053E−01 | −2.5543E−01 | 3.1927E−01 |
| 10 | −3.2813E−01 | −1.0730E−01 | 5.5279E−02 | 1.6402E−02 | −2.1767E−01 |
| 11 | 6.8160E−01 | −7.8102E−03 | 4.5330E−02 | −1.4331E−01 | 2.7337E−01 |
| 12 | −5.0000E+00 | 2.4076E−02 | −6.2421E−02 | 3.1157E−01 | −8.0404E−01 |
| 13 | −8.7741E−01 | 6.8761E−02 | −2.2900E−02 | −3.4950E−01 | 1.1743E+00 |
| 14 | −5.0000E+00 | 1.7053E−01 | −4.1969E−01 | 6.2982E−01 | −6.0701E−01 |
| 15 | −5.0997E−01 | 9.1717E−02 | −3.7769E−01 | 5.3805E−01 | −5.1526E−01 |
| 16 | −4.5647E+00 | −6.4245E−02 | 2.7459E−02 | −1.4514E−02 | 6.7780E−03 |
| 17 | −8.0204E−01 | −7.0008E−02 | 3.5753E−02 | −1.1290E−02 | 2.2911E−03 |
| 18 | −7.7198E−02 | −3.6538E−02 | 1.0535E−02 | −2.4010E−03 | 4.7974E−04 |
| Surface | | | | | |
| number | A12 | A14 | A16 | A18 | A20 |
| 1 | 4.8637E−05 | −4.3207E−06 | 2.4741E−07 | −8.2201E−09 | 1.1978E−10 |
| 2 | 3.5938E−04 | −7.5181E−05 | 9.5066E−06 | −6.6604E−07 | 2.0649E−08 |
| 3 | −2.9062E−03 | 8.9371E−04 | −1.3669E−04 | 1.0722E−05 | −3.4541E−07 |
| 4 | 2.9014E−02 | −6.7536E−03 | 9.7620E−04 | −7.9492E−05 | 2.7814E−06 |
| 5 | 3.7332E−02 | −9.5172E−03 | 1.4399E−03 | −1.1862E−04 | 4.0969E−06 |
| 6 | 1.8121E−02 | −5.9378E−03 | 1.1233E−03 | −1.1417E−04 | 4.8523E−06 |
| 7 | −2.0650E−02 | 1.2206E−02 | −4.3168E−03 | 8.2491E−04 | −6.7921E−05 |
| 8 | −1.4323E−01 | 7.3189E−02 | −2.4106E−02 | 4.6076E−03 | −3.8815E−04 |
| 9 | −2.8536E−01 | 1.7738E−01 | −7.1656E−02 | 1.6840E−02 | −1.7414E−03 |
| 10 | 4.3457E−01 | −4.4676E−01 | 2.6593E−01 | −8.6686E−02 | 1.2075E−02 |
| 11 | −3.6132E−01 | 3.1233E−01 | −1.6547E−01 | 4.8072E−02 | −5.6946E−03 |
| 12 | 1.2643E+00 | −1.2590E+00 | 7.6552E−01 | −2.6052E−01 | 3.8304E−02 |
| 13 | −1.9327E+00 | 1.8502E+00 | −1.0507E+00 | 3.2605E−01 | −4.2071E−02 |
| 14 | 3.9590E−01 | −1.7366E−01 | 4.8804E−02 | −7.8427E−03 | 5.4105E−04 |
| 15 | 3.3672E−01 | −1.4736E−01 | 4.1214E−02 | −6.6571E−03 | 4.7206E−04 |
| 16 | −2.3546E−03 | 5.5160E−04 | −8.1433E−05 | 6.8084E−06 | −2.4575E−07 |
| 17 | −3.0681E−04 | 2.7177E−05 | −1.5460E−06 | 5.1632E−08 | −7.7795E−10 |
| 18 | −7.9561E−05 | 9.3859E−06 | −6.9767E−07 | 2.8867E−08 | −5.0630E−10 |

TABLE 33
Various data (zoom ratio 1.493, image height 4.000)
(Table 33) Various data

| | Wide-angle | Intermediate | Telephoto |
|---|---|---|---|
| Focal length | 3.671 | 4.126 | 5.480 |
| F number | 1.753 | 1.859 | 2.172 |
| Half field of view | 65.015 | 50.984 | 35.497 |
| Total length of lens | 9.999 | 9.550 | 8.861 |
| d6 | 2.129 | 1.485 | 0.200 |
| d18 | 0.425 | 0.621 | 1.216 |

TABLE 34
Data of zoom lens groups

| | | | Configuration length | Movement amount |
|---|---|---|---|---|
| Group | Initial surface | Focal length | of lens | of lens |
| 1 | 1 | −7.226 | 1.753 | −1.138 |
| 2 | 7 | 2.970 | 5.241 | 0.791 |

TABLE 35
Magnifications of zoom lens groups

| Group | Initial surface | Wide-angle | Intermediate | Telephoto |
|---|---|---|---|---|
| 1 | 1 | 0.000 | 0.000 | 0.000 |
| 2 | 7 | −0.508 | −0.571 | −0.758 |

### Eighth Embodiment

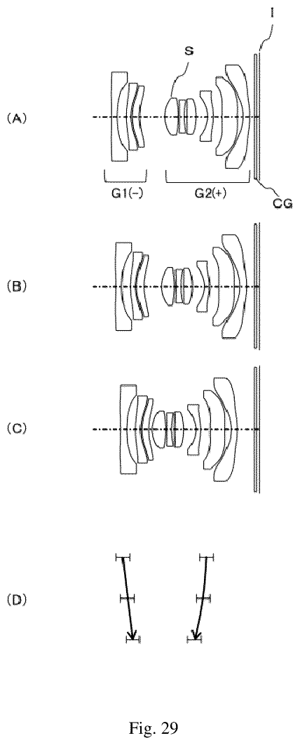

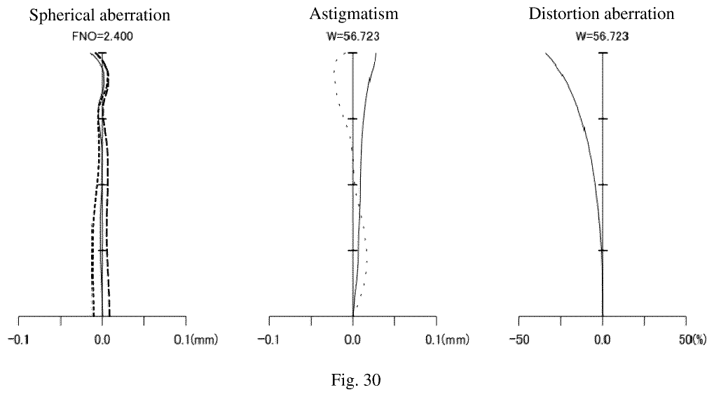

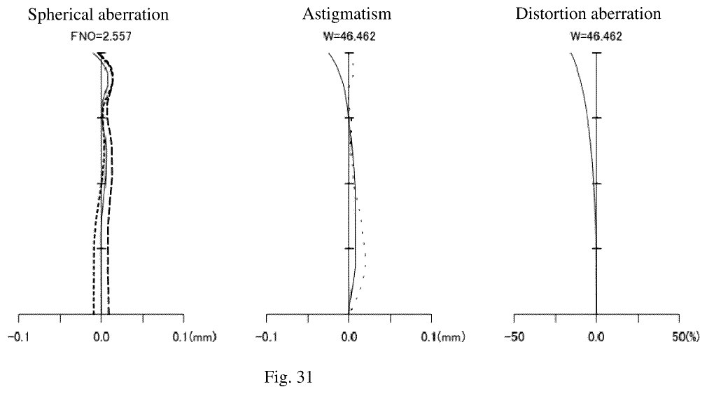

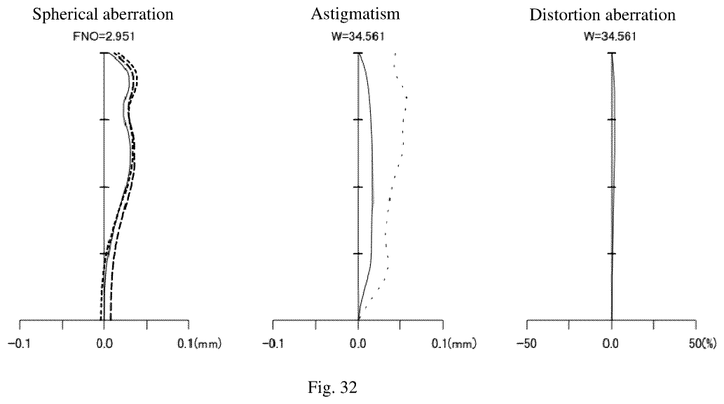

FIG. 29 is a lens layout view showing a wide-angle end state (FIG. 29 (A)), an intermediate focus position state (FIG. 29 (B)) and a telephoto end state (FIG. 29 (C)) of a zoom lens according to an embodiment (eighth embodiment) of this implementation, and a diagram showing a change of a first lens group G1 and a second lens group G2 from the wide-angle end state to the telephoto end state (FIG. 29 (D)). FIG. 30 is a longitudinal aberration diagram of the wide-angle end state of the eighth embodiment. FIG. 31 is a longitudinal aberration diagram of the intermediate focus position state of the eighth embodiment. FIG. 32 is a longitudinal aberration diagram of the telephoto end state of the eighth embodiment.

The zoom lens in the eighth embodiment has the first lens group G1 with a negative refractive power and the second lens group G2 with a positive refractive power, and an aperture stop S for adjusting a light quantity is arranged between the first lens group G1 and the second lens group G2. In addition, an optical filter CG including an infrared cut-off filter or the like is arranged between the second lens group G2 and an imaging position I.

In the eighth embodiment with the above configuration, in a process of zooming from the wide-angle end state to the telephoto end state, the first lens group G1 gradually moves toward an image side and the second lens group G2 gradually moves toward an object side. That is, the first lens group G1 and the second lens group G2 move by different trajectories to reduce an interval therebetween. The aperture stop S moves integrally with the second lens group G2.

In the following tables, values of parameters of the eighth embodiment are shown.

TABLE 36
Surface data

| Surface | | | | | |
|---|---|---|---|---|---|
| number | r | d | nd | νd | |
| 1* | −18.922 | 0.467 | 1.5445 | 55.97 | |
| 2* | 8.619 | 0.713 | | | |
| 3* | 6.182 | 0.400 | 1.5445 | 55.97 | |
| 4* | 3.937 | 0.100 | | | |
| 5* | 3.523 | 0.569 | 1.6714 | 19.27 | |
| 6* | 3.962 | d6 | | | |
| 7* | 2.316 | 1.078 | 1.5445 | 55.97 | (Aperture stop) |
| 8* | −5.707 | 0.100 | | | |
| 9* | 43.904 | 0.400 | 1.6714 | 19.27 | |
| 10* | 5.157 | 0.234 | | | |
| 11* | 40.315 | 0.698 | 1.5445 | 55.97 | |
| 12* | −4.697 | 1.000 | | | |
| 13* | −1.754 | 0.400 | 1.5781 | 36.36 | |
| 14* | −3.351 | 0.742 | | | |
| 15* | 12.789 | 1.230 | 1.6714 | 19.27 | |
| 16* | 16.780 | 0.484 | | | |
| 17* | −4.331 | 0.500 | 1.5445 | 55.97 | |
| 18* | −8.602 | d18 | | | |
| 19 | ∞ | 0.210 | 1.5168 | 64.17 | |
| 20 | ∞ | 0.240 | | | |

*represents aspheric surface

TABLE 37
Aspheric data (in which an aspheric coefficient not shown is 0.00)

| Surface | | | | | |
|---|---|---|---|---|---|
| number | k | A4 | A6 | A8 | A10 |
| 1 | −4.9971E+00 | 5.1655E−03 | −2.4320E−04 | −4.3617E−06 | 3.2284E−07 |
| 2 | −4.9558E+00 | 2.8032E−03 | 9.5329E−04 | −8.3216E−05 | 4.0962E−06 |
| 3 | −5.0000E+00 | −6.3863E−03 | −4.2261E−05 | 3.3747E−05 | −9.3331E−07 |
| 4 | −1.0828E+00 | 1.4905E−03 | −1.1380E−03 | −8.1040E−05 | 1.0447E−05 |
| 5 | −3.4612E+00 | −3.8986E−04 | 6.3092E−05 | −7.6094E−05 | −5.2554E−06 |
| 6 | −4.5894E+00 | −7.0130E−03 | 3.4455E−04 | 7.4847E−05 | −1.7818E−05 |
| 7 | −1.4175E−01 | 1.5962E−03 | −3.1262E−04 | 3.2801E−04 | −2.0604E−04 |
| 8 | −4.9998E+00 | 9.3442E−03 | −1.9981E−03 | 4.6509E−05 | 8.1368E−05 |
| 9 | −4.9746E+00 | −2.6257E−02 | 3.9425E−03 | 2.4108E−03 | −1.9843E−04 |
| 10 | 4.4989E+00 | −2.3065E−02 | 4.6083E−03 | 1.2136E−03 | 1.1062E−03 |
| 11 | 5.0000E+00 | 9.9418E−03 | −1.1211E−02 | −3.7655E−04 | 2.7406E−04 |
| 12 | 1.1045E+00 | 1.4261E−03 | −6.0976E−03 | −8.7577E−04 | −8.8550E−05 |
| 13 | −2.6189E+00 | 3.7663E−03 | −2.6184E−03 | −1.6685E−03 | 2.4075E−04 |
| 14 | −4.9994E+00 | 2.1017E−02 | 3.7626E−04 | −1.9890E−04 | −5.7747E−06 |
| 15 | −4.9933E+00 | −3.5287E−02 | 1.3229E−02 | −8.0817E−03 | 3.5996E−03 |
| 16 | −4.0490E+00 | −4.5952E−02 | 1.6089E−02 | −5.9477E−03 | 1.7121E−03 |
| 17 | −8.7393E−01 | −5.8181E−02 | 3.2004E−02 | −8.2083E−03 | 1.2054E−03 |
| 18 | −1.4320E+00 | −2.3012E−02 | 1.5969E−02 | −4.2122E−03 | 6.3242E−04 |
| Surface | | | | | |
| number | A12 | A14 | A16 | A18 | A20 |
| 1 | −2.7321E−10 | 5.9996E−12 | −1.2586E−13 | −7.8480E−15 | −7.5826E−16 |
| 2 | −1.0854E−09 | 1.8394E−11 | −1.1441E−13 | −1.3927E−15 | −1.9723E−17 |
| 3 | −2.0831E−10 | −3.0464E−12 | −1.1219E−13 | −1.4311E−15 | −1.9652E−17 |
| 4 | −9.4067E−10 | −1.7453E−10 | −1.1189E−13 | −1.5443E−15 | −1.9651E−17 |
| 5 | −5.6956E−09 | −2.8253E−10 | −1.0235E−13 | −1.3135E−15 | −1.6788E−17 |
| 6 | 5.4637E−11 | −1.1720E−11 | −1.2096E−13 | −1.5414E−15 | −1.9649E−17 |
| 7 | −2.3482E−07 | 8.6519E−09 | −1.2097E−13 | −1.5419E−15 | −1.9654E−17 |
| 8 | 1.6903E−07 | −3.4379E−09 | −1.2096E−13 | −1.5419E−15 | −1.9654E−17 |
| 9 | 5.9717E−07 | −1.7276E−08 | −1.2097E−13 | −1.5419E−15 | −1.9654E−17 |
| 10 | 1.2679E−06 | −3.5993E−08 | −1.2097E−13 | −1.5419E−15 | −1.9654E−17 |
| 11 | −3.3310E−08 | 3.3221E−10 | −1.2094E−13 | −1.5419E−15 | −1.9654E−17 |
| 12 | 9.7311E−09 | −3.9790E−10 | −1.2097E−13 | −1.5419E−15 | −1.9654E−17 |
| 13 | −6.8960E−10 | −8.1870E−12 | −1.0916E−13 | −1.5419E−15 | −1.9654E−17 |
| 14 | 1.3281E−09 | 1.6446E−11 | −1.2428E−13 | −1.5141E−15 | −1.9686E−17 |
| 15 | −1.0570E−03 | 2.0248E−04 | −2.4399E−05 | 1.6715E−06 | −4.9538E−08 |
| 16 | −3.4738E−04 | 4.6144E−05 | −3.7569E−06 | 1.6832E−07 | −3.1439E−09 |
| 17 | −1.1047E−04 | 6.6044E−06 | −2.5637E−07 | 5.9606E−09 | −6.3350E−11 |
| 18 | −5.9930E−05 | 3.6473E−06 | −1.3819E−07 | 2.9607E−09 | −2.7323E−11 |

TABLE 38
Various data (zoom ratio 1.432, image height 5.120)
(Table 38) Various data

| | Wide-angle | Intermediate | Telephoto |
|---|---|---|---|
| Focal length | 5.158 | 5.791 | 7.386 |
| F number | 2.400 | 2.557 | 2.951 |
| Half field of view | 56.723 | 46.462 | 34.561 |
| Total length of lens | 12.000 | 11.640 | 11.238 |
| d6 | 2.057 | 1.420 | 0.300 |
| d18 | 0.379 | 0.656 | 1.373 |

TABLE 39
Data of zoom lens groups
(Table 39) Data of zoom lens groups

| | | | Configuration length | Movement amount |
|---|---|---|---|---|
| Group | Initial surface | Focal length | of lens | of lens |
| 1 | 1 | −8.339 | 2.249 | −0.762 |
| 2 | 7 | 3.600 | 6.866 | 0.994 |

TABLE 40
Magnifications of zoom lens groups

| Group | Initial surface | Wide-angle | Intermediate | Telephoto |
|---|---|---|---|---|
| 1 | 1 | 0.000 | 0.000 | 0.000 |
| 2 | 7 | −0.618 | −0.694 | −0.886 |

### Ninth Embodiment

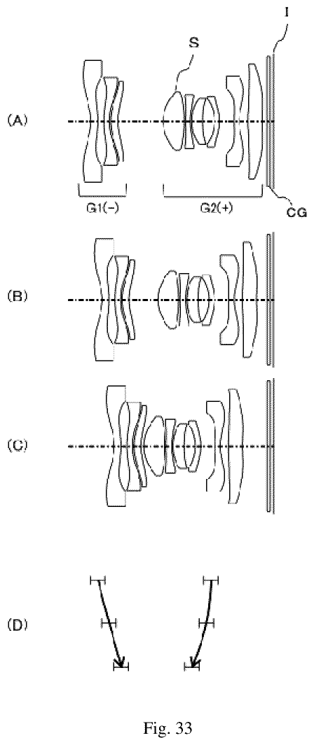

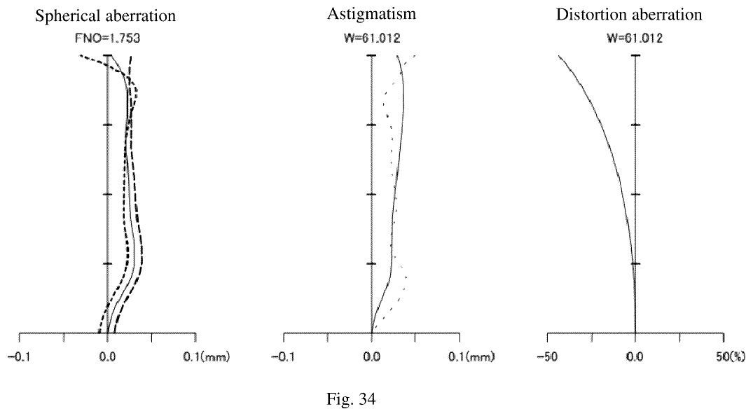

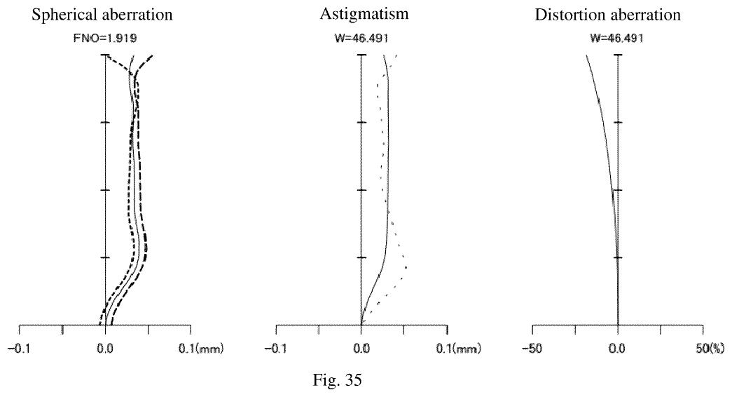

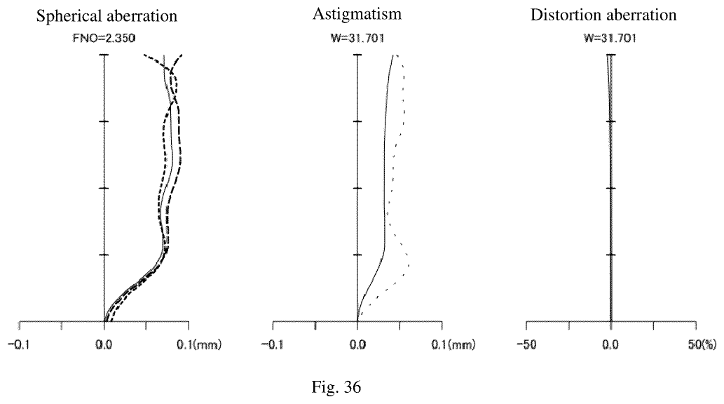

FIG. 33 is a lens layout view showing a wide-angle end state (FIG. 33 (A)), an intermediate focus position state (FIG. 33 (B)) and a telephoto end state (FIG. 33 (C)) of a zoom lens according to an embodiment (embodiment 9) of this implementation, and a diagram showing a change of a first lens group G1 and a second lens group G2 from the wide-angle end state to the telephoto end state (FIG. 33 (D)). FIG. 34 is a longitudinal aberration diagram of the wide-angle end state of the ninth embodiment. FIG. 35 is a longitudinal aberration diagram of the intermediate focus position state of the ninth embodiment. FIG. 36 is a longitudinal aberration diagram of the telephoto end state of the ninth embodiment.

The zoom lens in the ninth embodiment has the first lens group G1 with a negative refractive power and the second lens group G2 with a positive refractive power, and an aperture stop S for adjusting a light quantity is arranged between the first lens group G1 and the second lens group G2. In addition, an optical filter CG including an infrared cut-off filter or the like is arranged between the second lens group G2 and an imaging position I.

In the ninth embodiment with the above configuration, in a process of zooming from the wide-angle end state to the telephoto end state, the first lens group G1 gradually moves toward an image side and the second lens group G2 gradually moves toward an object side. That is, the first lens group G1 and the second lens group G2 move by different trajectories to reduce an interval therebetween. The aperture stop S moves integrally with the second lens group G2.

In the following tables, values of parameters of the ninth embodiment are shown.

TABLE 41
Surface data

| Surface | | | | | |
|---|---|---|---|---|---|
| number | r | d | nd | νd | |
| 1* | −3.245 | 0.500 | 1.5439 | 55.93 | |
| 2* | −8.252 | 0.504 | | | |
| 3* | 10.241 | 0.400 | 1.5439 | 55.93 | |
| 4* | 8.848 | 0.100 | | | |
| 5* | 3.625 | 0.565 | 1.6714 | 19.27 | |
| 6* | 3.623 | d6 | | | |
| 7* | 2.884 | 1.613 | 1.5439 | 55.93 | (Aperture stop) |
| 8* | −10.931 | 0.100 | | | |
| 9* | 10.186 | 0.400 | 1.6714 | 19.27 | |
| 10* | 3.876 | 0.100 | | | |
| 11* | 3.534 | 0.865 | 1.5439 | 55.93 | |
| 12* | 16.530 | 0.861 | | | |
| 13* | −2.858 | 0.400 | 1.6397 | 23.49 | |
| 14* | −3.088 | 1.125 | | | |
| 15* | 37.497 | 0.400 | 1.5439 | 55.93 | |
| 16* | 3.804 | 0.652 | | | |
| 17* | 10.673 | 1.081 | 1.6714 | 19.27 | |
| 18* | 13.132 | d18 | | | |
| 19 | ∞ | 0.210 | 1.5168 | 64.17 | |
| 20 | ∞ | 0.240 | | | |

*represents aspheric surface

TABLE 42
Aspheric data (in which an aspheric coefficient not shown is 0.00)

| Surface | | | | | |
|---|---|---|---|---|---|
| number | k | A4 | A6 | A8 | A10 |
| 1 | −4.2190E+00 | 8.5088E−03 | −8.9983E−04 | 1.0548E−04 | −1.0799E−05 |
| 2 | −2.0666E+00 | 6.5561E−03 | −1.0162E−04 | 2.1385E−04 | −8.1333E−05 |
| 3 | −3.9364E+00 | 2.3040E−02 | −1.3664E−02 | 3.1852E−03 | −4.0545E−04 |
| 4 | 1.5244E+00 | 5.4382E−02 | −2.5373E−02 | 8.0110E−03 | −2.0265E−03 |
| 5 | −4.5645E+00 | 9.5698E−04 | −4.4104E−03 | 3.8794E−03 | −1.6576E−03 |
| 6 | −4.8089E+00 | −1.9909E−02 | 6.4168E−03 | −1.4558E−03 | 1.6089E−04 |
| 7 | −4.3324E−01 | 9.6510E−04 | 7.7885E−04 | −1.0050E−03 | 7.9193E−04 |
| 8 | −5.0000E+00 | −1.4510E−02 | 2.0744E−02 | −1.8514E−02 | 1.0272E−02 |
| 9 | −4.8650E+00 | −5.3986E−02 | 4.0399E−02 | −3.2064E−02 | 1.8387E−02 |
| 10 | −1.7732E−01 | −5.6983E−02 | 4.5202E−02 | −3.2686E−02 | 1.5297E−02 |
| 11 | 1.3504E+00 | −1.2450E−02 | 2.8339E−02 | −2.3823E−02 | 1.2429E−02 |
| 12 | 5.0000E+00 | 1.4697E−02 | −6.2871E−03 | 1.9321E−02 | −2.4596E−02 |
| 13 | −5.8721E−01 | 1.7752E−02 | −7.1180E−04 | −1.1956E−02 | 1.4084E−02 |
| 14 | −3.2780E+00 | 2.2425E−02 | −6.9111E−03 | 6.3612E−04 | 1.6271E−03 |
| 15 | 5.0000E+00 | 3.2502E−03 | −9.9137E−03 | 7.1512E−04 | 1.3022E−03 |
| 16 | −3.2373E+00 | −5.7303E−03 | −5.4879E−03 | 2.3183E−03 | −5.3048E−04 |
| 17 | 2.3405E+00 | −1.6468E−02 | 3.1815E−03 | −3.7979E−04 | 2.9112E−05 |
| 18 | −4.6842E−01 | −1.4528E−02 | 1.8545E−03 | −1.8741E−04 | 1.3181E−05 |
| Surface | | | | | |
| number | A12 | A14 | A16 | A18 | A20 |
| 1 | 8.1526E−07 | −4.2634E−08 | 1.4578E−09 | −2.9152E−11 | 2.5713E−13 |
| 2 | 1.6612E−05 | −2.0651E−06 | 1.5673E−07 | −6.7334E−09 | 1.2670E−10 |
| 3 | 2.4177E−05 | 2.4548E−07 | −1.2953E−07 | 7.4213E−09 | −1.4648E−10 |
| 4 | 3.7150E−04 | −4.5640E−05 | 3.5244E−06 | −1.5416E−07 | 2.9124E−09 |
| 5 | 3.8852E−04 | −5.2291E−05 | 4.1506E−06 | −1.7970E−07 | 3.3009E−09 |
| 6 | 7.1960E−07 | −1.9071E−06 | 1.4586E−07 | −1.4898E−09 | −1.2416E−10 |
| 7 | −3.9601E−04 | 1.2247E−04 | −2.3299E−05 | 2.4723E−06 | −1.1563E−07 |
| 8 | −3.7099E−03 | 8.7053E−04 | −1.2831E−04 | 1.0796E−05 | −3.9721E−07 |
| 9 | −6.9829E−03 | 1.7401E−03 | −2.7301E−04 | 2.4430E−05 | −9.5058E−07 |
| 10 | −3.8951E−03 | 2.4722E−04 | 1.3825E−04 | −3.7006E−05 | 2.8864E−06 |
| 11 | −3.9849E−03 | 6.3734E−04 | 1.8235E−05 | −2.3846E−05 | 2.7453E−06 |
| 12 | 1.9479E−02 | −9.8256E−03 | 3.0362E−03 | −5.2528E−04 | 3.9001E−05 |
| 13 | −9.3594E−03 | 3.4211E−03 | −6.0109E−04 | 1.1659E−05 | 7.1108E−06 |
| 14 | −1.6147E−03 | 7.9506E−04 | −2.2608E−04 | 3.5510E−05 | −2.3332E−06 |
| 15 | −7.1303E−04 | 1.8652E−04 | −2.7601E−05 | 2.2032E−06 | −7.3259E−08 |
| 16 | 7.7991E−05 | −7.5352E−06 | 4.6011E−07 | −1.6000E−08 | 2.4015E−10 |
| 17 | −1.4029E−06 | 3.1605E−08 | 4.8906E−10 | −4.4493E−11 | 6.9763E−13 |
| 18 | −3.4383E−07 | −2.5812E−08 | 2.5010E−09 | −7.9694E−11 | 9.0139E−13 |

TABLE 43
Various data (zoom ratio 1.668, image height 5.120)
(Table 43) Various data

| | Wide-angle | Intermediate | Telephoto |
|---|---|---|---|
| Focal length | 5.025 | 5.954 | 8.382 |
| F number | 1.753 | 1.919 | 2.350 |
| Half field of view | 61.012 | 46.491 | 31.701 |
| Total length of lens | 13.999 | 13.134 | 12.217 |
| d6 | 3.454 | 2.187 | 0.200 |
| d18 | 0.428 | 0.831 | 1.901 |

TABLE 44
Data of zoom lens groups

| | | | Configuration length | Movement amount |
|---|---|---|---|---|
| Group | Initial surface | Focal length | of lens | of lens |
| 1 | 1 | −9.826 | 2.069 | −1.782 |
| 2 | 7 | 4.154 | 7.598 | 1.472 |

TABLE 45
Magnifications of zoom lens groups

| Group | Initial surface | Wide-angle | Intermediate | Telephoto |
|---|---|---|---|---|
| 1 | 1 | 0.000 | 0.000 | 0.000 |
| 2 | 7 | −0.511 | −0.606 | −0.853 |

### Tenth Embodiment

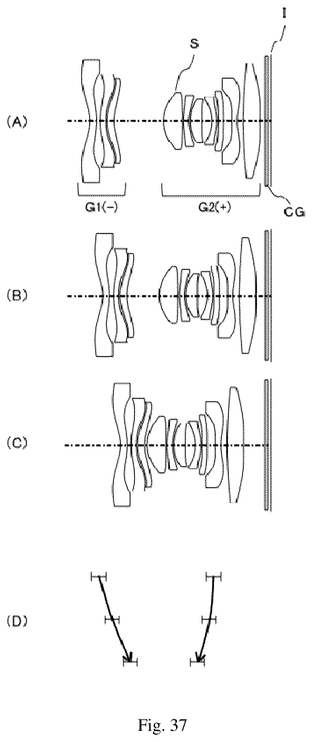

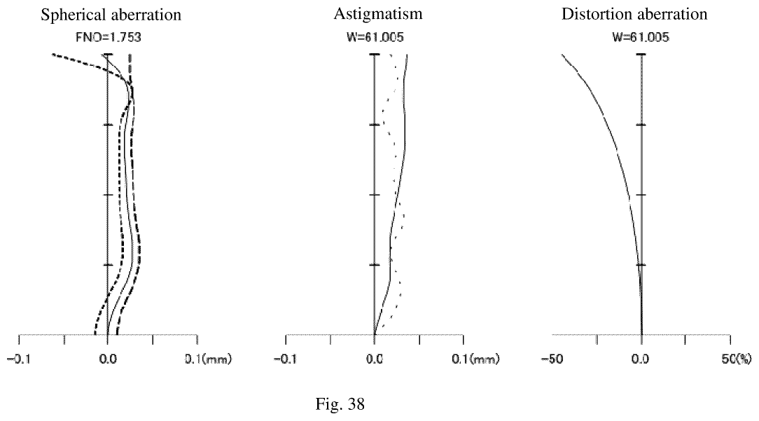

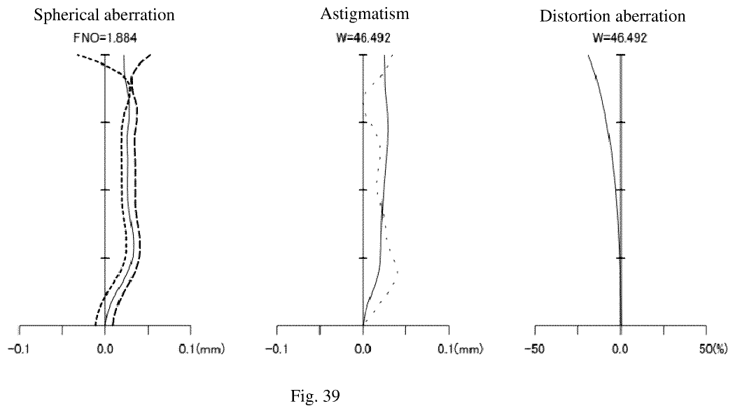

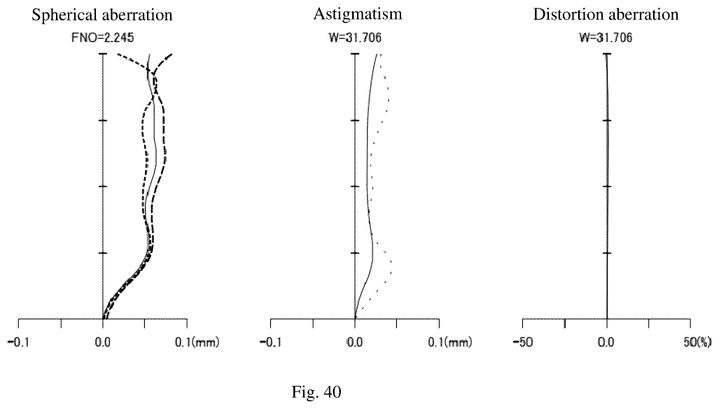

FIG. 37 is a lens layout view showing a wide-angle end state (FIG. 37 (A)), an intermediate focus position state (FIG. 37 (B)) and a telephoto end state (FIG. 37 (C)) of a zoom lens according to an embodiment (tenth embodiment) of this implementation, and a diagram showing a change of a first lens group G1 and a second lens group G2 from the wide-angle end state to the telephoto end state (FIG. 37 (D)). FIG. 38 is a longitudinal aberration diagram of the wide-angle end state of the tenth embodiment. FIG. 39 is a longitudinal aberration diagram of the intermediate focus position state of the tenth embodiment. FIG. 40 is a longitudinal aberration diagram of the telephoto end state of the tenth embodiment.

The zoom lens in the tenth embodiment has the first lens group G1 with a negative refractive power and the second lens group G2 with a positive refractive power, and an aperture stop S for adjusting a light quantity is arranged between the first lens group G1 and the second lens group G2. In addition, an optical filter CG including an infrared cut-off filter or the like is arranged between the second lens group G2 and an imaging position I.

In the tenth embodiment with the above configuration, in a process of zooming from the wide-angle end state to the telephoto end state, the first lens group G1 gradually moves toward an image side and the second lens group G2 gradually moves toward an object side. That is, the first lens group G1 and the second lens group G2 move by different trajectories to reduce an interval therebetween. The aperture stop S moves integrally with the second lens group G2.

In the following tables, values of parameters of the tenth embodiment are shown.

TABLE 46
Surface data

| Surface | | | | | |
|---|---|---|---|---|---|
| number | r | d | nd | νd | |
| 1* | −2.954 | 0.500 | 1.5439 | 55.93 | |
| 2* | −5.813 | 0.306 | | | |
| 3* | 8.128 | 0.412 | 1.5439 | 55.93 | |
| 4* | 8.381 | 0.100 | | | |
| 5* | 3.141 | 0.522 | 1.6714 | 19.27 | |
| 6* | 2.943 | d6 | | | |
| 7* | 2.776 | 1.457 | 1.5439 | 55.93 | (Aperture stop) |
| 8* | −59.779 | 0.100 | | | |
| 9* | 4.723 | 0.400 | 1.6714 | 19.27 | |
| 10* | 2.946 | 0.120 | | | |
| 11* | 3.445 | 0.886 | 1.5439 | 55.93 | |
| 12* | −497.957 | 0.779 | | | |
| 13* | −2.637 | 0.400 | 1.6714 | 19.27 | |
| 14* | −3.521 | 0.100 | | | |
| 15* | −32.437 | 0.400 | 1.5439 | 55.93 | |
| 16* | −32.241 | 0.652 | | | |
| 17* | −90.402 | 0.400 | 1.5439 | 55.93 | |
| 18* | 4.051 | 0.480 | | | |
| 19* | 13.226 | 1.305 | 1.6714 | 19.27 | |
| 20* | 57.050 | d20 | | | |
| 21 | ∞ | 0.210 | 1.5168 | 64.17 | |
| 22 | ∞ | 0.240 | | | |

*represents aspheric surface

TABLE 47
Aspheric data (in which an aspheric coefficient not shown is 0.00)

| Surface | | | | | |
|---|---|---|---|---|---|
| number | k | A4 | A6 | A8 | A10 |
| 1 | −3.8500E+00 | 8.4075E−03 | −6.4845E−04 | 5.4869E−05 | −4.1457E−06 |
| 2 | −5.0000E+00 | −1.2597E−03 | 3.4999E−03 | −7.9982E−04 | 1.1454E−04 |
| 3 | −5.0000E+00 | 2.3556E−02 | −1.4780E−02 | 3.9593E−03 | −6.3848E−04 |
| 4 | −6.1128E−01 | 6.1865E−02 | −2.7875E−02 | 7.9411E−03 | −1.7474E−03 |
| 5 | −4.8142E+00 | −1.5044E−03 | −9.6712E−04 | 2.1433E−03 | −1.2056E−03 |
| 6 | −4.9674E+00 | −2.1926E−02 | 9.2777E−03 | −2.6984E−03 | 4.4707E−04 |
| 7 | −4.0843E−01 | 1.9584E−03 | 5.2608E−05 | 4.6266E−04 | −6.0770E−04 |
| 8 | −5.0000E+00 | −1.1296E−02 | 2.4241E−02 | −2.2864E−02 | 1.3263E−02 |
| 9 | −3.9657E+00 | −4.4177E−02 | 3.8696E−02 | −3.3332E−02 | 1.9544E−02 |
| 10 | −4.8924E−01 | −4.6489E−02 | 3.3959E−02 | −2.2250E−02 | 6.7625E−03 |
| 11 | 1.6063E+00 | −4.8603E−03 | 1.7349E−02 | −9.8667E−03 | −3.3219E−04 |
| 12 | 5.0000E+00 | 1.0051E−02 | −3.7752E−03 | 1.4774E−02 | −1.7866E−02 |
| 13 | −3.5215E−01 | 1.2596E−02 | 1.4096E−03 | −7.5610E−03 | 9.8428E−03 |
| 14 | −4.2319E+00 | 3.2747E−02 | −4.7999E−02 | 5.4702E−02 | −3.9915E−02 |
| 15 | 5.0000E+00 | 3.7736E−02 | −7.2715E−02 | 5.6541E−02 | −2.7452E−02 |
| 16 | 5.0000E+00 | 2.9087E−02 | −3.4955E−02 | 1.5834E−02 | −3.4019E−03 |
| 17 | −5.0000E+00 | −1.9195E−03 | −1.5776E−02 | 4.6809E−03 | −5.6684E−04 |
| 18 | −4.6666E+00 | −1.4382E−02 | −2.9141E−03 | 1.8333E−03 | −4.7224E−04 |
| 19 | −5.0000E+00 | −1.3224E−02 | 3.7048E−03 | −6.2081E−04 | 6.6870E−05 |
| 20 | 5.0000E+00 | −9.9393E−03 | 1.2854E−03 | −1.7010E−04 | 2.8118E−05 |
| Surface | | | | | |
| number | A12 | A14 | A16 | A18 | A20 |
| 1 | 2.0920E−07 | −6.3168E−09 | 9.5711E−11 | −1.9445E−13 | −8.6559E−15 |
| 2 | −1.0032E−05 | 4.5858E−07 | −2.7143E−09 | −6.7661E−10 | 2.1257E−11 |
| 3 | 6.5648E−05 | −4.3930E−06 | 1.8773E−07 | −4.6680E−09 | 5.0759E−11 |
| 4 | 2.8641E−04 | −3.2914E−05 | 2.4606E−06 | −1.0610E−07 | 1.9834E−09 |
| 5 | 3.2078E−04 | −4.7841E−05 | 4.1326E−06 | −1.9437E−07 | 3.8639E−09 |
| 6 | −3.5445E−05 | 1.7541E−08 | 2.2141E−07 | −1.6129E−08 | 3.9372E−10 |
| 7 | 4.1665E−04 | −1.6625E−04 | 3.7982E−05 | −4.6398E−06 | 2.2548E−07 |
| 8 | −5.1070E−03 | 1.2905E−03 | −2.0654E−04 | 1.9006E−05 | −7.6685E−07 |
| 9 | −7.7360E−03 | 2.0618E−03 | −3.5312E−04 | 3.5252E−05 | −1.5620E−06 |
| 10 | 6.1939E−04 | −1.2579E−03 | 4.5148E−04 | −7.3650E−05 | 4.7254E−06 |
| 11 | 3.9332E−03 | −2.6471E−03 | 8.9645E−04 | −1.6079E−04 | 1.2223E−05 |
| 12 | 1.3816E−02 | −6.8162E−03 | 2.0453E−03 | −3.4277E−04 | 2.4615E−05 |
| 13 | −7.3529E−03 | 2.7954E−03 | −4.2108E−04 | −3.3764E−05 | 1.2685E−05 |
| 14 | 1.9915E−02 | −6.7959E−03 | 1.5339E−03 | −2.0675E−04 | 1.2578E−05 |
| 15 | 8.1101E−03 | −1.1822E−03 | −1.0820E−05 | 2.7273E−05 | −2.6699E−06 |
| 16 | −1.6899E−04 | 3.2323E−04 | −8.5157E−05 | 9.8130E−06 | −4.3418E−07 |
| 17 | −8.9766E−05 | 5.0698E−05 | −8.6596E−06 | 6.8573E−07 | −2.1257E−08 |
| 18 | 7.4569E−05 | −7.6293E−06 | 4.9376E−07 | −1.8603E−08 | 3.1498E−10 |
| 19 | −4.7708E−06 | 2.2949E−07 | −7.4231E−09 | 1.5062E−10 | −1.4595E−12 |
| 20 | −3.6112E−06 | 2.8892E−07 | −1.3545E−08 | 3.4115E−10 | −3.5625E−12 |

TABLE 48
Various data (zoom ratio 1.607, image height 5.120)
(Table 48) Various data

| | Wide-angle | Intermediate | Telephoto |
|---|---|---|---|
| Focal length | 5.161 | 5.989 | 8.294 |
| F number | 1.753 | 1.884 | 2.245 |
| Half field of view | 61.005 | 46.492 | 31.706 |
| Total length of lens | 13.999 | 12.995 | 11.611 |
| d6 | 3.828 | 2.501 | 0.200 |
| d20 | 0.401 | 0.725 | 1.641 |

TABLE 49
Data of zoom lens groups

| | | | Configuration length | Movement amount |
|---|---|---|---|---|
| Group | Initial furface | Focal length | of lens | of lens |
| 1 | 1 | −11.364 | 1.840 | −2.388 |
| 2 | 7 | 4.362 | 7.480 | 1.240 |

TABLE 50
Magnifications of zoom lens groups

| Group | Initial surface | Wide-angle | Intermediate | Telephoto |
|---|---|---|---|---|
| 1 | 1 | 0.000 | 0.000 | 0.000 |
| 2 | 7 | −0.454 | −0.527 | −0.730 |

In the above description, as this implementation, the zoom lenses in the first to tenth embodiments have been described. In addition, it should be noted that the magnifications of the zoom lens groups in the first to tenth embodiments are calculated based on a case that an object distance is infinite. Here, the correspondence between conditional expressions and the embodiments in this implementation will be described. The conditional expressions are as follows.

$$Conditional expression ( 1 ) = OAL 2 / OALw ,$$

OAL2: an axial length of a second lens group from an object side to an image side; and
OALw: an axial length of a first lens group at a wide-angle end from an object side to an image plane.

$$Conditional expression ( 2 ) = f 1 / f 2 ,$$

f1: a focal length of a first lens group; and
f2: a focal length of a second lens group.

$$Conditional expression ( 3 ) = f 2 / √ ( fw \times f t ) ,$$

f2: a focal length of a second lens group;
fw: a focal length at a wide-angle end; and
ft: a focal length at a telephoto end.

$$Conditional expression ( 4 ) = L 1 R 1 / L 1 R 2 ,$$

in which
L1R1: a radius of curvature of an object-side surface of a lens closest to an object side; and
L1R2: a radius of curvature of an image-side surface of the lens closest to the object side.

$$Conditional expression ( 5 ) = OALw / √ ( fw \times f t ) ,$$

in which
OALw: an axial length of a first lens group at a wide-angle end from an object side to an image plane;
fw: a focal length at the wide-angle end; and
ft: a focal length at a telephoto end.

$$Conditional expression ( 6 ) = m 1 / m 2 ,$$

m1: a movement amount of a first lens group toward an object side when zooming from a wide-angle end to a telephoto end; and
m2: a movement amount of a second lens group toward the object side when zooming from the wide-angle end to the telephoto end.

$$Conditional expression ( 7 ) = ( OALt - m 2 ) / √ ( fw \times f t ) ,$$

in which
OALt: an axial length of a first lens group at a telephoto end from an object side to an image plane;
m2: a movement amount of a second lens group toward the object side when zooming from a wide-angle end to the telephoto end;
fw: a focal length at the wide-angle end; and
ft: a focal length at the telephoto end.

Table 51 shows the values and parameters of the above conditional expressions in the first to tenth embodiments.

TABLE 51
Corresponding values of conditional expressions

| | 1st | 2nd | 3rd | 4th | 5th | 6th | 7th | 8th | 9th | 10th |
|---|---|---|---|---|---|---|---|---|---|---|
| | embodi- | embodi- | embodi- | embodi- | embodi- | embodi- | embodi- | embodi- | embodi- | embodi- |
| | ment | ment | ment | ment | ment | ment | ment | ment | ment | ment |
| Conditional | 0.498 | 0.516 | 0.522 | 0.522 | 0.523 | 0.526 | 0.524 | 0.572 | 0.543 | 0.534 |
| expression (1) | | | | | | | | | | |
| Conditional | −2.014 | −2.135 | −2.254 | −2.320 | −2.329 | −2.583 | −2.433 | −2.316 | −2.365 | −2.605 |
| expression (2) | | | | | | | | | | |
| Conditional | 0.587 | 0.599 | 0.600 | 0.624 | 0.651 | 0.645 | 0.662 | 0.583 | 0.640 | 0.667 |
| expression (3) | | | | | | | | | | |
| Conditional | −4.057 | −2.919 | −0.509 | −0.298 | 0.238 | 0.272 | 0.320 | −2.195 | 0.393 | 0.508 |
| expression (4) | | | | | | | | | | |
| Conditional | 2.150 | 2.205 | 2.212 | 2.256 | 2.270 | 2.146 | 2.229 | 1.944 | 2.157 | 2.140 |
| expression (5) | | | | | | | | | | |
| Conditional | −0.349 | −0.570 | −0.724 | −0.984 | −1.107 | −1.638 | −1.439 | −0.767 | −1.210 | −1.926 |
| expression (6) | | | | | | | | | | |
| Conditional | 1.841 | 1.873 | 1.868 | 1.873 | 1.858 | 1.729 | 1.799 | 1.660 | 1.656 | 1.585 |
| expression (7) | | | | | | | | | | |
| OAL2 | 4.727 | 5.053 | 5.112 | 5.219 | 5.225 | 5.104 | 5.241 | 6.866 | 7.598 | 7.480 |
| OALw | 9.500 | 9.800 | 9.800 | 10.000 | 10.000 | 9.699 | 9.999 | 12.000 | 13.999 | 13.999 |
| f1 | −5.228 | −5.684 | −5.990 | −6.414 | −6.680 | −7.526 | −7.226 | −8.339 | −9.826 | −11.364 |
| f2 | 2.596 | 2.662 | 2.658 | 2.764 | 2.869 | 2.913 | 2.970 | 3.600 | 4.154 | 4.362 |
| fw | 3.544 | 3.585 | 3.590 | 3.589 | 3.582 | 3.727 | 3.671 | 5.158 | 5.025 | 5.161 |
| ft | 5.510 | 5.510 | 5.469 | 5.473 | 5.418 | 5.482 | 5.480 | 7.386 | 8.382 | 8.294 |
| L1R1 | −18.782 | −15.048 | −6.544 | −5.798 | −3.839 | −2.897 | −2.772 | −18.922 | −3.245 | −2.954 |
| L1R2 | 4.629 | 5.156 | 12.856 | 19.458 | −16.153 | −10.666 | −8.673 | 8.619 | −8.252 | −5.813 |
| m1 | −0.353 | −0.535 | −0.640 | −0.844 | −0.953 | −1.170 | −1.138 | −0.762 | −1.782 | −2.388 |
| m2 | 1.013 | 0.939 | 0.884 | 0.857 | 0.861 | 0.714 | 0.791 | 0.994 | 1.472 | 1.240 |
| OALt | 9.147 | 9.265 | 9.160 | 9.156 | 9.047 | 8.530 | 8.861 | 11.238 | 12.217 | 11.611 |

As shown in Table 51, for the first to tenth embodiments, conditional expression (1) satisfies a following range:

$$0.38 \leq O A L 2 / O A L w \leq 0.80 .$$

In addition, conditional expression (2) satisfies a following range:

$$- 5.00 \leq f 1 / f 2 \leq - 1.30 .$$

In addition, conditional expression (3) satisfies a following range:

$$0.1 \leq f 2 / √ ( fw \times f t ) \leq 0.90 .$$

In addition, conditional expression (4) satisfies a following range:

$$- 10.00 \leq L 1 R 1 / L 1 R 2 \leq 0.90 .$$

In addition, conditional expression (5) satisfies a following range:

$$1.2 \leq OALw / √ ( fw \times f t ) \leq 3.00 .$$

In addition, conditional expression (6) satisfies a following range:

$$- 2.00 \leq m 1 / m 2 \leq - 0.20 .$$

In addition, conditional expression (7) satisfies a following range:

$$0.5 \leq ( OALt - m 2 ) / √ ( fw \times f t ) \leq 5. .$$

With these conditional expressions satisfying the above ranges, it is possible to provide a zoom lens and a photographing device which are small and thin as a whole and may photograph with a wide angle, a high brightness and a high performance. In addition, in a case that at least any one of conditional expressions (1) to (4) satisfies the above range, an effect of a small and thin zoom lens may be obtained compared with the existing zoom lens. On the other hand, on the premise that any one of conditional expressions (1) to (4) satisfies the above range, in a case that at least one of conditional expressions (5) to (7) is satisfied, an effect of a smaller and thinner zoom lens may be obtained.

Moreover, in addition to the above embodiments, experiments are conducted repeatedly, and as a result, it is confirmed that better effects may be obtained in the following ranges.

For conditional expression (1),

$$0.42 \leq OAL 2 / OALw \leq 0.70 .$$

More preferably,

$$0.46 \leq O A L 2 / O A L w \leq 0.60 .$$

For conditional expression (2),

$$- 4.00 \leq f 1 / f 2 \leq - 1.60 .$$

More preferably,

$$- 3.00 \leq f 1 / f 2 \leq - 1.80 .$$

For conditional expression (3),

$$0.3 \leq f 2 / √ ( fw \times f t ) \leq 0.80 .$$

More preferably,

$$0.5 \leq f 2 / √ ( fw \times f t ) \leq 0.70 .$$

For conditional expression (4),

$$- 7.00 \leq L 1 R 1 / L 1 R 2 \leq 0.80 .$$

More preferably,

$$- 5.00 \leq L 1 R 1 / L 1 R 2 \leq 0.70 .$$

For conditional expression (5),

$$1.5 \leq OALw / √ ( fw \times f t ) \leq 2.70 .$$

More preferably,

$$1.8 \leq OALw / √ ( fw \times f t ) \leq 2.40 .$$

For conditional expression (6),

$$- 1.97 \leq m 1 / m 2 \leq - 0.25 .$$

More preferably,

$$- 1.94 \leq m 1 / m 2 \leq - 0.30 .$$

For conditional expression (7),

$$1. \leq ( O A L t - m2 ) / √ ( fw \times f t ) \leq 3.50 .$$

More preferably,

$$1.5 \leq ( O A L t - m 2 ) / √ ( fw \times f t ) \leq 2. .$$

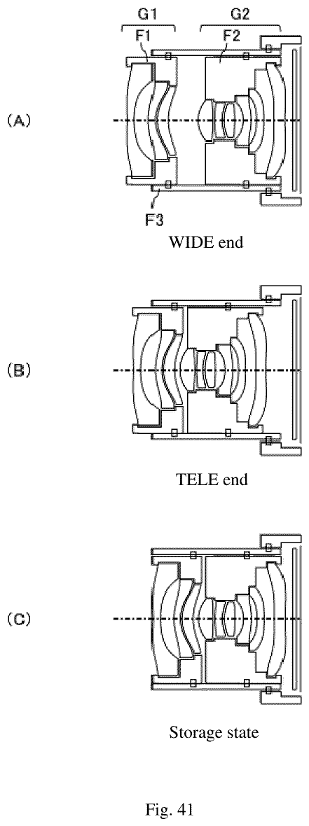

Next, a structure of a lens barrel supporting the first lens group G1 and the second lens group G2 will be described. FIG. 41 is a view showing the lens barrel in a wide-angle end state (FIG. 41 (A)), a telephoto end state (FIG. 41 (B)) and a storage state (FIG. 41 (C)). As shown in the view, the first lens group G1 is supported on a first frame F1, and the second lens group G2 is supported on a second frame F2. The first frame F1 and the second frame F2 are supported on a integral frame F3 in such a way that they advance and retreat independently in a direction of an optical axis. In the storage state, the first frame F1 moves to be closest to an image side relative to the integral frame F3, thus realizing a compact storage state as a whole.

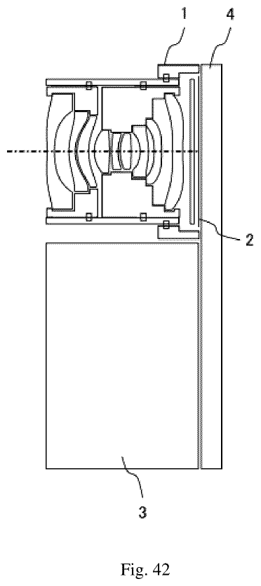

FIG. 42 is a schematic view showing a structure of a photographing device. The photographing device mainly includes: a lens barrel 1 which supports a lens group; a photographing element 2 which converts an optical image imaged by the lens group into an electrical signal; a computational processing component 3 which processes photoelectrically converted image signal; and a liquid crystal panel 4 which displays processed image data as an image. In addition, as the photographing device having the zoom lens of this implementation, a digital still camera, a digital video camera, a surveillance camera, a smart phone, a PC, a tablet terminal, a driving recorder and the like are listed, which are particularly suitable for the photographing device that is expected to be thinned.

According to the present disclosure, it is possible to provide a zoom lens and a photographing device which are small and thin as a whole and may photograph with a wide angle, a high brightness and a high performance.

A zoom lens in a first configuration of the present disclosure includes a first lens group with a negative refractive power and a second lens group with a positive refractive power in sequence from an object side. When zooming from a wide-angle end to a telephoto end, the first lens group and the second lens group move by different trajectories to reduce an interval therebetween, and a following conditional expression is satisfied.

$$0.38 \leq OAL 2 / OALw \leq 0.80 \qquad ( 1 )$$

OAL2: an axial length of the second lens group from the object side to an image side.
OALw: an axial length of the first lens group at the wide-angle end from the object side to an image plane.

According to the first configuration, the first lens group with the negative refractive power is arranged closest to the object side, and the second lens group with the positive refractive power is arranged on the image side. Therefore, a retro-focus optical power configuration is provided, and a wide-angle optimization may be realized by shortening a focal length at the wide-angle end.

Conditional expression (1) specifies a ratio of the axial length of the second lens group from the object side to the image side to the axial length of the first lens group from the object side to the image plane at the wide-angle end (a ratio of a total length of the second lens group to a total length at the wide-angle end). In a negative lead-type zoom lenses using the first lens group with the negative refractive power, the total length generally becomes the longest at the wide-angle end. When the zoom lens zooms, the focal length is changed by changing the interval of respective groups, while in a case that an air interval is increased, a movement amount of this part may be increased, and a magnification change ratio may be ensured, but resulting in a disadvantage that the total length at the wide-angle end becomes longer.

In the zoom lens of the first configuration, both thinning and brightness (i.e., an F number is small) may be achieved by minimizing the air interval and increasing the total length of the second lens group. In a case that this value is lower than a lower limit, the total length of the second lens group becomes smaller and the number of lenses in the second lens group is reduced, so that an aberration correction becomes insufficient, and it is difficult to form a bright zoom lens. In addition, in a case that this value is higher than an upper limit, it is difficult to obtain a desired magnification change ratio because the air interval becomes smaller.

A zoom lens in a second configuration of the present disclosure includes a first lens group with a negative refractive power and a second lens group with a positive refractive power in sequence from an object side. When zooming from a wide-angle end to a telephoto end, the first lens group and the second lens group move by different trajectories to reduce an interval therebetween, and a following conditional expression is satisfied.

$$- 5.00 \leq f 1 / f 2 \leq - 1.30 \qquad ( 2 )$$

f1: a focal length of the first lens group.
f2: a focal length of the second lens group.

According to the second configuration, the first lens group with the negative refractive power is arranged closest to the object side, and the second lens group with the positive refractive power is arranged on an image side. Therefore, a retro-focus optical power configuration is provided, so that a wide-angle optimization may be realized by shortening a focal length at the wide-angle end.

Conditional expression (2) specifies a ratio of the focal length of the first lens group to the focal length of the second lens group. In the zoom lens having the first lens group with the negative refractive power and the second lens group with the positive refractive power in sequence from the object side, the first lens group and the second lens group change their intervals from an image plane for zooming. In order to ensure a magnification change ratio, it is necessary to enhance the optical power of each group and ensure an air interval to such an extent that each group may move effectively. However, in a negative lead-type zoom lenses, in a case that an optical power of the first lens group is to be enhanced, an outer diameter of the first lens group tends to become larger, so that a thickness of a peripheral part of a lens becomes obviously thicker, thus the first lens group itself becomes thicker, and a total length of the zoom lens cannot be avoided from becoming longer.

In the zoom lens of the second configuration, in order to make the first lens group thinner, weaken the negative optical power, and achieve a smaller F number, the optical power of the second lens group is enhanced. In a case that this value is lower than a lower limit, the optical power of the first lens group becomes too weak, and it is difficult to obtain a desired magnification change ratio. In addition, in a case that this value is higher than an upper limit, the optical power of the first lens group is enhanced, but the first lens group itself becomes thicker, thus making it difficult to reduce the total length.

A zoom lens in a third configuration of the present disclosure has a first lens group with a negative refractive power and a second lens group with a positive refractive power in sequence from an object side. When zooming from a wide-angle end to a telephoto end, the first lens group and the second lens group move by different trajectories to reduce an interval therebetween, and a following conditional expression is satisfied.

$$0.1 \leq f 2 / √ ( fw \times f t ) \leq 0.90 \qquad ( 3 )$$

f2: a focal length of the second lens group.
fw: a focal length at the wide-angle end.
ft: a focal length at the telephoto end.

According to the third configuration, the first lens group with the negative refractive power is arranged closest to the object side, and the second lens group with the positive refractive power is arranged on an image side. Therefore, a retro-focus optical power configuration is provided, so that a wide-angle optimization may be realized by shortening the focal length at the wide-angle end.

Conditional expression (3) specifies a ratio of the focal length of the second lens group to an effective focal length of the zoom lens. In the zoom lens having the first lens group with the negative refractive power and the second lens group with the positive refractive power in sequence from the object side, it is difficult to form a bright optical system in a case that a positive optical power of the second lens group is weak.

In a case that this value is lower than a lower limit, the effective focal length serving as a denominator is large, so that it becomes difficult for the wide-angle optimization. In addition, in a case that this value is higher than an upper limit, the focal length of the second lens group is large and the optical power of the second lens group is weak, so that it is difficult to form a bright zoom lens.

A zoom lens in a fourth configuration of the present disclosure has a first lens group with a negative refractive power and a second lens group with a positive refractive power in sequence from an object side. When zooming from a wide-angle end to a telephoto end, the first lens group and the second lens group move by different trajectories to reduce an interval therebetween, and a following conditional expression is satisfied.

$$- 10.00 \leq L 1 R 1 / L 1 R 2 \leq 0.90 \qquad ( 4 )$$

L1R1: a radius of curvature of an object-side surface of a lens closest to the object side.
L1R2: a radius of curvature of an image-side surface of the lens closest to the object side.

According to the fourth configuration, the first lens group with the negative refractive power is arranged closest to the object side, and the second lens group with the positive refractive power is arranged on the image side. Therefore, a retro-focus optical power configuration is provided, so that a wide-angle optimization may be realized by shortening a focal length at the wide-angle end.

Conditional expression (4) specifies a ratio of the radius of curvature of the object-side surface of the lens closest to the object side to the radius of curvature of the image-side surface of the lens closest to the object side. In a case that the lens closest to the object side of a wide-angle lens is a spherical lens, a negative meniscus lens protruding toward the object side is generally arranged. This is because, for a light beam incident at a large angle with respect to an optical axis, in a case that an angle of a peripheral part with respect to a plane normal becomes larger, not only an aberration correction becomes difficult, but also a reflectivity becomes higher, thus the wide-angle lens is not preferred. Therefore, the angle of the peripheral part with respect to the plane normal is mostly designed to be smaller, that is, in a case that the lens is the spherical lens, it is designed to configure the lens closest to the object side as the negative meniscus lens that protrudes toward the object side. However, in order to realize a bright lens system with a short total length, for an axial light beam, the object-side surface of the lens closest to the object side is preferably concave toward the object side, and when viewed only from the radius of curvature on the axis, the lens closest to the object side is preferably a negative meniscus lens or a biconcave lens concave toward the object side.

In a case that this value is lower than a lower limit, a negative optical power of the object-side surface of the lens closest to the object side becomes weak, and an aberration correction such as a spherical aberration of the axial light beam becomes insufficient, thus making it difficult to form a bright zoom lens. In addition, in a case that this value is higher than an upper limit, the negative optical power on the axis becomes weak, so that a negative focal length becomes weak, the focal length cannot be shortened, and it is difficult to realize the wide-angle optimization.

A zoom lens in a fifth configuration of the present disclosure is the zoom lens in any of the first to fourth configurations, and when zooming, a first lens group moves to be closest to an image side at a telephoto end.

According to the fifth configuration, a first lens group with a negative refractive power and a second lens group with a positive refractive power are arranged in sequence from an object side, and when zooming from a wide-angle end to the telephoto end, the first lens group and the second lens group move by different trajectories to reduce an interval therebetween. In a case that the first lens group is a negative zoom lens with a negative refractive power, when a magnification change ratio becomes larger, the moving trajectory of the first lens group sometimes is a moving trajectory concave toward the object side, but in a process that the first lens group and the second lens group move to reduce the interval, when the first lens group moves toward the object side, the second lens group usually also moves toward the object side. In the negative zoom lens, an aperture is usually arranged in the second lens group or in front of or behind the second lens group, and the second lens group moves toward the object side, in which the farther away from an image plane, the larger an F number is.

In the zoom lens of the fifth configuration, as a wide-angle, bright and high-performance zoom lens, when zooming, the first lens group moves to be closest to the image side at the telephoto end, so that even at the telephoto end, photographing may be performed with a smaller F number, and the second lens group does not move toward the object side too much.

A zoom lens in a sixth configuration of the present disclosure is the zoom lens in any of the first to fourth configurations, and a following conditional expression is satisfied.

$$1.2 \leq OALw / √ ( fw \times f t ) \leq 3.00 \qquad ( 5 )$$

OALw: an axial length of a first lens group at a wide-angle end from an object side to an image plane.
fw: a focal length at the wide-angle end.
ft: a focal length at a telephoto end.

Conditional expression (5) specifies a ratio of the axial length of the first lens group at the wide-angle end from the object side to the image plane to an effective focal length of the zoom lens. In a negative zoom lens using the first lens group with the negative refractive power, a total length generally becomes the longest at the wide-angle end. When the zoom lens zooms, the focal length is changed by changing the interval of respective groups, while in a case that an air interval is increased, a movement amount of this part may be increased, and a magnification change ratio may be ensured, but resulting in a disadvantage that the total length at the wide-angle end becomes longer. In a case that the full length at the wide-angle end becomes longer, a mechanical structure becomes complicated and the number of parts increases when constructing a telescopic lens, so that it is not preferable. In the zoom lens of the sixth configuration, a small and thin zoom lens may be provided by minimizing the air interval and keeping the axial length of the first lens group at the wide-angle end from the object side to the image plane short.

In a case that this value is lower than a lower limit, the axial length of the first lens group at the wide-angle end from the object side to the image plane is too short, and it is difficult to ensure the desired magnification change ratio. In addition, in a case that this value is higher than an upper limit, the total length at the wide-angle end becomes longer, and the mechanical structure becomes complicated and the number of parts increases when constructing the telescopic lens, so that miniaturization becomes difficult.

A zoom lens according to a seventh configuration of the present disclosure is the zoom lens in any of the first to fourth configurations, and a following conditional expression is satisfied.

$$- 2.00 \leq m 1 / m 2 \leq - 0.20 \qquad ( 6 )$$

m1: a movement amount of a first lens group toward an object side when zooming from a wide-angle end to a telephoto end.
m2: a movement amount of a second lens group toward the object side when zooming from the wide-angle end to the telephoto end.

Conditional expression (6) specifies a ratio of the movement amount of the first lens group toward the object side when zooming from the wide-angle end to the telephoto end to the movement amount of the second lens group toward the object side when zooming from the wide-angle end to the telephoto end. In a negative zoom lens having a first lens group with a negative refractive power and a second lens group with a positive refractive power, in which the first lens group and the second lens group move by different trajectories to reduce an interval therebetween when zooming from the wide-angle end to the telephoto end, in a case that the movement amount of the first lens group is large, a mechanical structure becomes complicated and the number of parts increases when constructing a telescopic lens, so that miniaturization becomes difficult. In addition, in a case that the movement amount of the second lens group is large, an aperture is usually arranged in the second lens group or in front of or behind the second lens group, and the second lens group moves toward the object side, in which the farther away from an image plane, the larger an F number is. Therefore, in the zoom lens of the seventh configuration, the optimum conditions are determined.

In a case that this value is lower than a lower limit, the movement amount of the first lens group toward the object side becomes too large when zooming from the wide-angle end to the telephoto end, and the mechanical structure becomes complicated and the number of parts increases, so that miniaturization becomes difficult. In addition, in a case that this value is higher than an upper limit, the movement amount of the second lens group toward the object side becomes too large when zooming from the wide-angle end to the telephoto end, and it becomes difficult to construct a bright zoom lens at the telephoto end in particular.

A zoom lens in an eighth configuration of the present disclosure is the zoom lens in any of the first to fourth configurations. In a state where no photographing is performed, a first lens group is moved to be closer to an image side than a telephoto end, and is stored.

The zoom lens of the eighth configuration of the present disclosure is made to be applied to a zoom lens and a photographing device which are small and thin as a whole and may photograph with a wide angle, a high brightness and a high performance, and its greatest effect is to adopt a telescopic structure when not in use. In a negative zoom lens, as a trajectory of the first lens group moving from a wide-angle end to a telephoto end, it includes a case of simply moving toward an object side and a case of moving with a curve concave toward the object side. In a case that the telescopic structure is adopted when not in use, the first lens group may be moved to be closer to the image side than a position of the telephoto end, so that the thickness of the lens and the thickness of the product may be reduced when stored.

A zoom lens in a ninth configuration of the present disclosure is a zoom lens in any of the first to fourth configurations, and a following conditional expression is satisfied.

$$0.5 \leq ( O A L t - m 2 ) / √ ( fw \times f t ) \leq 5. \qquad ( 7 )$$

OALt: an axial length of a first lens group at a telephoto end from an object side to an image plane.
m2: a movement amount of a second lens group toward the object side when zooming from a wide-angle end to the telephoto end.
fw: a focal length at the wide-angle end.
ft: a focal length at the telephoto end.

Conditional expression (7) specifies a ratio of a length obtained by subtracting the axial length of the first lens group at the telephoto end from the object side to the image plane from the movement amount of the second lens group toward the object side when zooming from the wide-angle end to the telephoto end to an effective focal length of the zoom lens. The zoom lens in the ninth configuration is made to be applied to a zoom lens and a photographing device which are small and thin as a whole and may photograph with a wide angle, a high brightness and a high performance, and its greatest effect is to adopt a telescopic structure when not in use. In a negative zoom lens, the first lens group and the second lens group are closest to each other at the telephoto end, and an interval between them becomes the smallest. In this case, the second lens group moves toward the object side. In a case that the interval between the first lens group and the second lens group at the telephoto end is maintained, by reducing an interval between the image plane and the second lens group at the wide-angle end, the thickness of the lens and the thickness of the product may be reasonably reduced when stored.

In a case that this value is lower than a lower limit, the thickness of each group becomes too thin, so that an aberration correction of each group becomes insufficient, and it is difficult to form a bright and high-performance zoom lens. In addition, in a case that this value is higher than an upper limit, it is difficult to reduce the thickness of the lens and the thickness of the product when stored.

A zoom lens in a tenth configuration of the present disclosure is the zoom lens in any of the first to fourth configurations, and has a field of view angle in a range of 122˜63.4°, that is, the field of view angle is in a range of 122˜63.4° from a wide-angle end to a telephoto end.

A zoom lens in an eleventh configuration of the present disclosure is the zoom lens in any of the first to fourth configurations, and further has an image sensor, and a photosensitive element in the image sensor has a size in a range of 1 inch˜½ inch.

A zoom lens in a twelfth configuration of the present disclosure is the zoom lens in any of the first to fourth configurations, and an equivalent focal length of the zoom lens is in a range of 12 mm˜35 mm.

A zoom lens in a thirteenth configuration of the present disclosure is the zoom lens in any of the first to fourth configurations, and a minimum focusing distance of the zoom lens is 10 cm.

A photographing device in a fourteenth configuration of the present disclosure includes the zoom lens in any of the first to fourth configurations, and a photographing element that converts a formed optical image into an electrical signal.

1. A zoom lens, comprising a first lens group with a negative refractive power and a second lens group with a positive refractive power in sequence from an object side, wherein in a case of zooming from a wide-angle end to a telephoto end, the first lens group and the second lens group move by different trajectories to reduce an interval therebetween, and a following conditional expression is satisfied:
$$\underline{0.38 \leq OAL 2 / OALw \leq 0.8 ,}$$
wherein
OAL2: an axial length of the second lens group from the object side to an image side; and
OALw: an axial length of the first lens group at the wide-angle end from the object side to an image plane.

2. A zoom lens, comprising a first lens group with a negative refractive power and a second lens group with a positive refractive power in sequence from an object side, wherein in a case of zooming from a wide-angle end to a telephoto end, the first lens group and the second lens group move by different trajectories to reduce an interval therebetween, and a following conditional expression is satisfied:
$$\underline{- 5. 0 \leq f 1 / f 2 \leq - 1.3 ,}$$
wherein
f1: a focal length of the first lens group; and
f2: a focal length of the second lens group.

3. A zoom lens, comprising a first lens group with a negative refractive power and a second lens group with a positive refractive power in sequence from an object side, wherein in a case of zooming from a wide-angle end to a telephoto end, the first lens group and the second lens group move by different trajectories to reduce an interval therebetween, and a following conditional expression is satisfied:
$$\underline{0.1 \leq f 2 / \sqrt{( f w \times f t )} \leq 0.9 ,}$$
wherein
f2: a focal length of the second lens group;
fw: a focal length at the wide-angle end; and
ft: a focal length at the telephoto end.

4. (canceled)

5. The zoom lens according to claim 1, wherein the first lens group moves to be closest to an image side at the telephoto end in a case of zooming.

6. The zoom lens according to claim 1, wherein the zoom lens satisfies a following conditional expression:
$$1.20 \leq OALw / \sqrt{( f w \times f t )} \leq 3.00 ,$$
wherein
OALw: an axial length of the first lens group at the wide-angle end from the object side to an image plane;
fw: a focal length at the wide-angle end; and
ft: a focal length at the telephoto end.

7. The zoom lens according to claim 1, wherein the zoom lens satisfies a following conditional expression:
$$\underline{- 2. \leq m 1 / m 2 \leq - 0.2 ,}$$
wherein
m1: a movement amount of the first lens group toward the object side in a case of zooming from the wide-angle end to the telephoto end; and
m2: a movement amount of the second lens group to the object side in a case of zooming from the wide-angle end to the telephoto end.

8. The zoom lens according to claim 1, wherein in a case that no photographing is performed, the first lens group is moved to be closer to an image side than a position of the telephoto end, and is stored.

9. The zoom lens according to claim 1, wherein the zoom lens satisfies a following conditional expression:
$$\underline{0.5 \leq ( OALt - m 2 ) / \sqrt{( fw \times f t )} \leq 5. ,}$$
wherein
OALt: an axial length of the first lens group at the telephoto end from the object side to an image plane;
m2: a movement amount of the second lens group toward the object side in a case of zooming from the wide-angle end to the telephoto end;
fw: a focal length at the wide-angle end; and
ft: a focal length at the telephoto end.

10. A photographing device, comprising a zoom lens according to claim 1, and a photographing element configured to convert an optical image generated by the zoom lens into an electrical signal.

11. A photographing device, comprising a zoom lens according to claim 2, and a photographing element configured to convert an optical image generated by the zoom lens into an electrical signal.

12. The zoom lens according to claim 2, wherein the first lens group moves to be closest to an image side at the telephoto end in a case of zooming.

13. The zoom lens according to claim 2, wherein the zoom lens satisfies a following conditional expression:
$$1.2 \leq OALw / \sqrt{( f w \times f t )} \leq 3.00 ,$$
wherein
OALw: an axial length of the first lens group at the wide-angle end from the object side to an image plane;
fw: a focal length at the wide-angle end; and
ft: a focal length at the telephoto end.

14. The zoom lens according to claim 2, wherein the zoom lens satisfies a following conditional expression:
$$- 2.00 \leq m 1 / m 2 \leq - 0.20 ,$$
wherein
m1: a movement amount of the first lens group toward the object side in a case of zooming from the wide-angle end to the telephoto end; and
m2: a movement amount of the second lens group to the object side in a case of zooming from the wide-angle end to the telephoto end.

15. The zoom lens according to claim 2, wherein in a case that no photographing is performed, the first lens group is moved to be closer to an image side than a position of the telephoto end, and is stored.

16. The zoom lens according to claim 2, wherein the zoom lens satisfies a following conditional expression:
$$0.5 \leq ( OALt - m 2 ) / \sqrt{( f w \times f t )} \leq 5.00 ,$$
wherein
OALt: an axial length of the first lens group at the telephoto end from the object side to an image plane;
m2: a movement amount of the second lens group toward the object side in a case of zooming from the wide-angle end to the telephoto end;
fw: a focal length at the wide-angle end; and
ft: a focal length at the telephoto end.

17. The zoom lens according to claim 3, wherein the first lens group moves to be closest to an image side at the telephoto end in a case of zooming.

18. The zoom lens according to claim 3, wherein the zoom lens satisfies a following conditional expression:
$$1.21 \leq OALw / \sqrt{( f w \times f t )} 3.00 ,$$
wherein
OALw: an axial length of the first lens group at the wide-angle end from the object side to an image plane;
fw: a focal length at the wide-angle end; and
ft: a focal length at the telephoto end.

19. The zoom lens according to claim 3, wherein the zoom lens satisfies a following conditional expression:
$$- 2.00 \leq m 1 / m 2 \leq - 0.20 ,$$
wherein
m1: a movement amount of the first lens group toward the object side in a case of zooming from the wide-angle end to the telephoto end; and
m2: a movement amount of the second lens group to the object side in a case of zooming from the wide-angle end to the telephoto end.

20. The zoom lens according to claim 3, wherein in a case that no photographing is performed, the first lens group is moved to be closer to an image side than a position of the telephoto end, and is stored.

21. The zoom lens according to claim 3, wherein the zoom lens satisfies a following conditional expression:
$$0.5 \leq ( OALt - m 2 ) / \sqrt{( f w \times f t )} \leq 5.00 ,$$
wherein
OALt: an axial length of the first lens group at the telephoto end from the object side to an image plane;
m2: a movement amount of the second lens group toward the object side in a case of zooming from the wide-angle end to the telephoto end;
fw: a focal length at the wide-angle end; and
ft: a focal length at the telephoto end.
